(19) United States
(12) Patent Application Publication
(10) Pub. No.: US 2025/0217823 A1
(43) Pub. Date: Jul. 3, 2025

(54) SYSTEM AND METHOD FOR GENERATING SIMULATED CHARACTERS FOR POPULATION GROUPS

(71) Applicant: State Farm Mutual Automobile Insurance Company, Bloomington, IL (US)

(72) Inventor: Edward W. Breitweiser, Bloomington, IL (US)

(73) Assignee: State Farm Mutual Automobile Insurance Company, Bloomington, IL (US)

(21) Appl. No.: 18/651,387

(22) Filed: Apr. 30, 2024

Related U.S. Application Data
(60) Provisional application No. 63/616,970, filed on Jan. 2, 2024.
(60) Provisional application No. 63/625,430, filed on Jan. 26, 2024.
(60) Provisional application No. 63/572,222, filed on Mar. 30, 2024.

(51) Int. Cl. G06Q 30/0201; G06N 20/00

(52) U.S. Cl. CPC G06Q 30/0201; G06N 20/00

(57) ABSTRACT

A computer-implemented method may include determining a respective simulated population for each simulated character of multiple simulated characters based upon respective characteristic values associated with each simulated character. Determining the respective simulated population may include: (a) determining a respective associated population group of multiple population groups for a real-life population based upon each simulated character; (b) determining respective member characteristics for the respective associated population group; and/or (c) generating each simulated member of the respective simulated population. Generating each simulated member may include associating each simulated member with one or more respective altered characteristic values altered based upon the respective characteristic values associated with each simulated character and the respective member characteristics for the respective associated population group. Other embodiments are disclosed.

### CROSS-REFERENCE TO RELATED APPLICATIONS

This application claims priority to U.S. Provisional Patent Application No. 63/616,970, filed Jan. 2, 2024, U.S. Provisional Patent Application No. 63/625,430, filed Jan. 26, 2024, and U.S. Provisional Patent Application No. 63/572,222, filed Mar. 30, 2024. U.S. Provisional Patent Application Nos. 63/616,970, 63/625,430, and 63/572,222 are incorporated herein by reference in their entirety.

### FIELD OF THE DISCLOSURE

The present disclosure generally relates to generally to techniques for natural language processing based upon generative artificial intelligence.

### BACKGROUND

Conventional generative artificial intelligence systems may be trained based upon a large amount of data collected from various data sources. Such systems, as trained, may generally simulate human interactions of the general public. However, if a system to simulate interactions by a specific population is needed, the system has to go through the protracted data collecting and training process.

Therefore, systems and methods for dynamically generating a simulated population and/or synthesizing responses based upon the simulated population are desired. Conventional techniques may include additional drawbacks, inefficiencies, ineffectiveness, and/or encumbrances, as well.

### BRIEF SUMMARY

The present embodiments may generally relate to, inter alia, generating and using virtual or simulated characters and/or avatars to synthesize a simulated population (or simulated group), as well as to simulate responses by a (real world or actual) population (or group or market segment). Generating a simulated population with various alterable characteristics may provide insights into various changes or courses of action being completed by entities, such as price changes, product or service changes or modifications, company policy changes impacting employees, reward policy changes, marketing strategies, new advertisements, etc. For instance, various proposed changes or related inquiries may be feed into the simulated or virtual characters and/or simulated or virtual population/group to determine if such proposed changes (such as product modifications) will be positively or negatively accepted by the simulated characters/population, and/or determine alternate courses of action from responses received from the population/group.

More specifically, various embodiments may include a computer-implemented method for generating and using simulated or virtual characters to synthesize a simulated population (or simulated group) in order to simulate responses by a (real world or actual) population (or group) (such as a real world: group of similarly situated individuals; members of a group or organization; market segment; users of a given product or service; customers of company; employees of a company; those that live in a given state or region; affinity groups; etc. as discussed further elsewhere herein). The method may be implemented via execution of computing instructions configured to run at one or more local or remote processors and stored at one or more local or remote non-transitory computer-readable media. In many embodiments, the method may include determining simulated characters for population groups or segments for a real-life population (or group) based upon member characteristics for the population groups. Each of the simulated characters may be associated with: (a) one of the population groups, and/or (b) respective characteristic values corresponding to the member characteristics. Examples of the real-life population or groups may include insurance policyholders for an insurance company (such as for auto, homeowners, renters, life, health, personal articles, and other types of insurance); customers of a retailer; users of a product or service; owners of vehicles manufactured by an automobile manufacture; customers of bank; loan holders; customers of financial services providers; members of a target or niche market; affinity groups, and/or other groups or populations mentioned elsewhere herein.

In one aspect, a computer system for generating simulated responses via simulated characters may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, InstructGPT bots, Codex bots, Google Bard bots, and/or other electronic or electrical components, which may be in wired or wireless communication with one another. For instance, in one aspect, the computer system may include one or more local or remote processors and/or associated transceivers; and one or more local or remote non-transitory computer-readable media storing computing instructions that, when run on the one or more processors, direct the one or more processors to perform one or more actions or operations. The instructions may direct the computer systems and/or processor(s) to: (1) determine simulated characters for population groups for a real-life population based upon (actual) member characteristics for the (real world) population groups. Each of the simulated characters may be associated with: (a) one of the (real world) population groups, and/or (b) respective characteristic values corresponding to the (actual) member characteristics. The instructions may also direct the computer systems and/or processor(s) to: (2) determine one or more matched simulated characters of the simulated characters for one or more known members of the real-life population based upon one or more known-member characteristic values associated with the one or more known members; (3) determine a simulated population for the real-life population based upon the one or more matched simulated characters; (4) generate one or more simulated responses to an inquiry for the one or more known members based upon the simulated population; and/or (5) transmit the one or more simulated responses to be displayed on a user interface on a user device. The computer system may be configured to include additional, less, or alternate functionality, including that discussed elsewhere herein.

In another aspect, a computer system for training a model based upon simulated responses and user feedback may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, InstructGPT bots, Codex bots, Google Bard bots, and/or other electronic or electrical components, which may be in wired or wireless communication with one another. For instance, in one aspect, the computer system may include one or more local or remote processors and/or associated transceivers; and one or more local or remote non-transitory computer-readable media storing computing instructions that, when run on the one or more processors, direct the one or more processors to perform one or more actions or operations. The instructions may direct the computer systems and/or processor(s) to: (1) generate, by a trained response-generating model, one or more simulated responses to an inquiry for one or more known members based upon a simulated population for a real-life population; (2) transmit the one or more simulated responses to be displayed on a user interface on a user device; (3) receive, from the user device, user feedback for the one or more simulated responses; and/or (4) re-train the trained response-generating model based upon the one or more simulated responses and the user feedback. The computer system may be configured with and/or include additional, less, or alternative functionality including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of a computer system that is suitable for implementing an exemplary embodiment of the system disclosed in FIG. 3;

FIG. 2 illustrates a representative block diagram of an example of the elements included in the circuit boards inside a chassis of the computer system of FIG. 1;

FIG. 3 illustrates a computer system for generating and using simulated characters to synthesize a simulated population in order to simulate responses by a real-life population, according to one exemplary embodiment;

FIG. 4 illustrates a flow chart for a computer-implemented or computer-based method for generating and using simulated characters to synthesize a simulated population in order to simulate responses by a real-life population, according to one exemplary embodiment;

FIG. 5 illustrates a flow chart for a computer-implemented or computer-based method for generating and using simulated characters to synthesize a simulated population in order to simulate responses by a population, according to one exemplary embodiment;

FIGS. 6-8 illustrate a flow chart for a computer-implemented or computer-based method for simulating real-life responses by a population, according to one exemplary embodiment;

FIGS. 9-10 illustrate a flow chart for a computer-implemented or computer-based method for generating and using simulated characters to synthesize a simulated population in order to simulate responses by an intellectual property review board, according to one exemplary embodiment;

FIGS. 11-12 illustrate a flow chart for a computer-implemented or computer-based method for generating and using simulated characters to synthesize a simulated population in order to simulate responses by a population of insurance policyholders, according to one exemplary embodiment;

FIG. 13 illustrates a flow chart for a computer-implemented or computer-based method for determining a simulated population based upon simulated characters, according to one exemplary embodiment; and

FIG. 14 illustrates a flow chart for a computer-implemented or computer-based method for generating simulated responses by a real-life population to user inquiries, according to one exemplary embodiment.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, generating simulated characters, determining simulated populations, and/or creating simulated responses by a real-life population (such as a group, market segments, customers of a specific company, users of a specific product or service, an affinity group, members of an organization, fans of sports team, other groups mentioned elsewhere herein, etc.)

In many embodiments, the techniques described herein may provide a practical application and several technological improvements. The techniques described herein may provide a technical improvement to machine learning and/or artificial intelligent systems. In particular, the techniques described here may: (a) generate simulated characters representative of various population groups of a target real-life population; (b) create a synthesized population based upon the simulated characters; and/or (c) simulate the real-life population's responses to user inquiries (such as by generating virtual or simulated responses to inquiries). These techniques described herein may provide a significant improvement over conventional approaches that use the information about the general public or non-segmented population for training NLP systems and thus may not easily and dynamically simulate answers correctly reflecting the opinions of the target population without the time-consuming retraining every time a different real-life population or group is targeted.

In certain aspects, simulated characters for one or more real-life population groups based upon member characteristics are determined. Each of the simulated characters may be associated with: (a) a population group (such as customers of a specific product or service, affinity group, and/or other population groups or groups, including those discussed elsewhere herein), and/or (b) respective characteristic values corresponding to the member characteristics. One or more matched simulated characters of the simulated characters for one or more known members of the real-life population (or group) may be determined based upon one or more known-member characteristic values associated with the one or more known members. A simulated population for the real-life population (or group) may be determined based upon the one or more matched simulated characters. One or more simulated responses to an inquiry for the one or more known members may be determined based upon the simulated population (or group). The one or more simulated responses may be transmitted to and displayed on a user interface on a user device.

In other aspects, a computer-implemented method may include determining a respective simulated population (or group) for each simulated character of multiple simulated characters based upon respective characteristic values associated with each simulated character. Determining the respective simulated population (or group) may include: (a) determining a respective associated population group of multiple population groups for a real-life population based upon each simulated character; (b) determining respective member characteristics for the respective associated population group; and/or (c) generating each simulated member of the respective simulated population. Generating each simulated member may include associating each simulated member with one or more respective altered characteristic values altered based upon the respective characteristic values associated with each simulated character and the respective member characteristics for the respective associated population group.

In yet other aspects, a computer-implemented method may include generating, by a trained response-generating model, one or more simulated responses to an inquiry for one or more known members based upon a simulated population for a real-life population (or group). The method further may include (i) transmitting simulated responses to be displayed on a user interface on a user device; and/or (ii) receiving, from the user device, user feedback for the one or more simulated responses. The method may also include re-training the trained response-generating model based upon the simulated responses and/or the user feedback. The methods may include additional, less, or alternate actions, including those discussed elsewhere herein.

### Exemplary Computer Systems

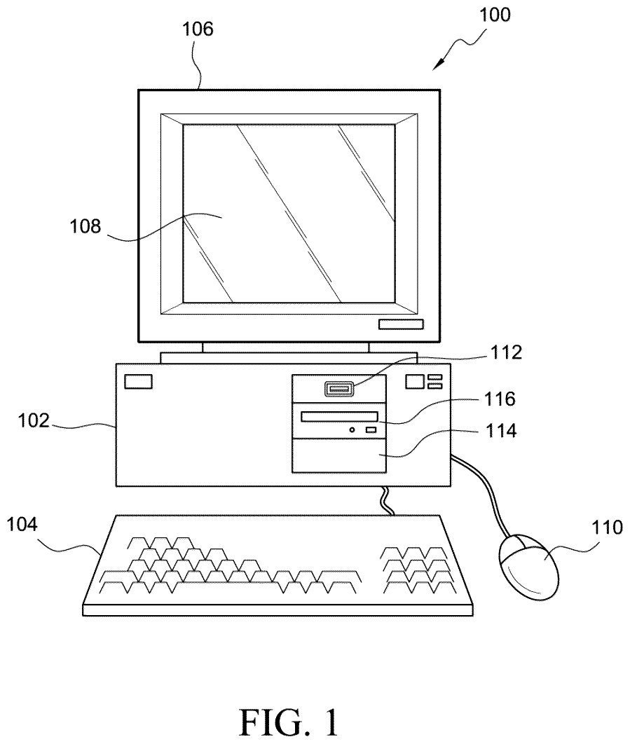

Turning to the drawings, FIG. 1 illustrates an exemplary embodiment of a computer system 100, all of which or a portion of which may be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) may be suitable for implementing part, or all of, the techniques described herein. Computer system 100 may comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114.

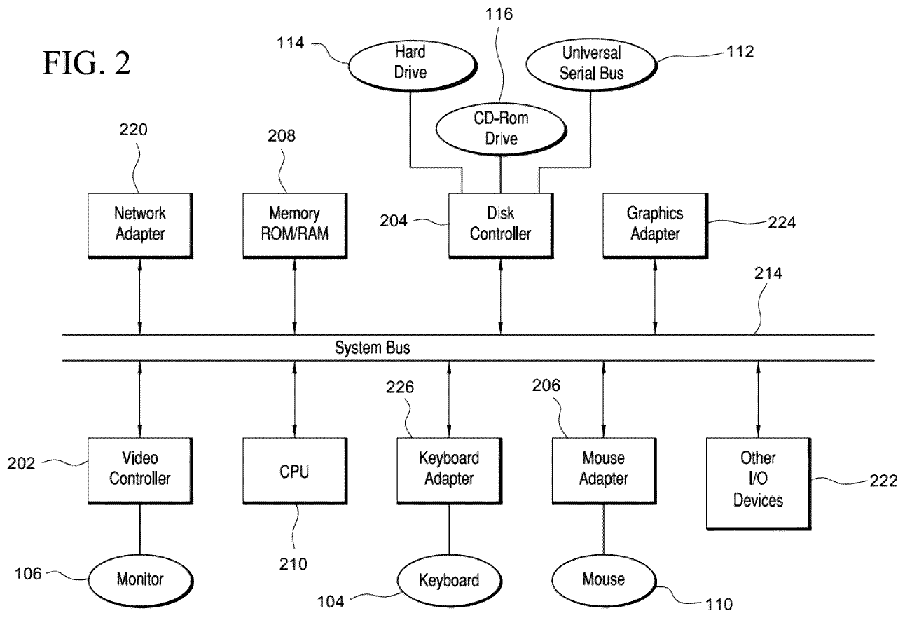

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 may be compliant with any of a variety of commercially distributed architecture families.

Continuing with FIG. 2, system bus 214 may also be coupled to memory storage unit 208 that includes both read only memory (ROM) and random access memory (RAM). Non-volatile portions of memory storage unit 208 or the ROM may be encoded with a boot code sequence suitable for restoring computer system 100 (FIG. 1) to a functional state after a system reset. In addition, memory storage unit 208 may include microcode such as a Basic Input-Output System (BIOS). In some examples, the one or more memory storage units of the various embodiments disclosed herein may include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2).

Non-volatile or non-transitory memory storage unit(s) refer to the portions of the memory storage units(s) that are non-volatile memory and not a transitory signal. In the same or different examples, the one or more memory storage units of the various embodiments disclosed herein may include an operating system, which may be a software program that manages the hardware and software resources of a computer and/or a computer network. The operating system may perform basic tasks such as, for example, controlling and allocating memory, prioritizing the processing of instructions, controlling input and output devices, facilitating networking, and managing files. Exemplary operating systems may include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS.

Further exemplary operating systems may comprise one of the following: (i) the iOS® operating system by Apple Inc. of Cupertino, California, United States of America, (ii) the Blackberry® operating system by Research In Motion (RIM) of Waterloo, Ontario, Mayada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein may comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 may be coupled to system bus 214. Keyboard adapter 226 and mouse adapter 206 may be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 may be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 may control hard drive 114 (FIGS. 1-2), USB port 112 (FIGS. 1-2), and CD-ROM and/or DVD drive 116 (FIGS. 1-2). In other embodiments, distinct units may be used to control each of these devices separately.

In some embodiments, network adapter 220 may comprise and/or be implemented as a WNIC (wireless network interface controller) card (not shown) plugged or coupled to an expansion port (not shown) in computer system 100 (FIG. 1). In other embodiments, the WNIC card may be a wireless network card built into computer system 100 (FIG. 1). A wireless network adapter may be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 may comprise and/or be implemented as a wired network interface controller card (not shown).

Although many other components of computer system 100 are not shown, such components and their interconnection are well known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, may be suitable for carrying out all or at least part of the techniques described herein. In various embodiments, computer system 100 may be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components may reside at various times in different storage components of computer system 100, and may be executed by CPU 210. Alternatively, or in addition to, the systems and procedures described herein may be implemented in hardware, or a combination of hardware, software, and/or firmware. For example, one or more application specific integrated circuits (ASICs) may be programmed to carry out one or more of the systems and procedures described herein. For example, one or more of the programs and/or executable program components described herein may be implemented in one or more ASICS.

Although computer system 100 is illustrated as a desktop computer in FIG. 1, there may be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers may be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone, smart glasses, smart watch, wearable, virtual reality headset, augmented reality glasses, etc. In certain additional embodiments, computer system 100 may comprise an embedded system.

Exemplary Computer Systems for Determining Simulated Characters, Generating Simulated Populations, and/or Simulating Responses Associated with a Real-Life Population

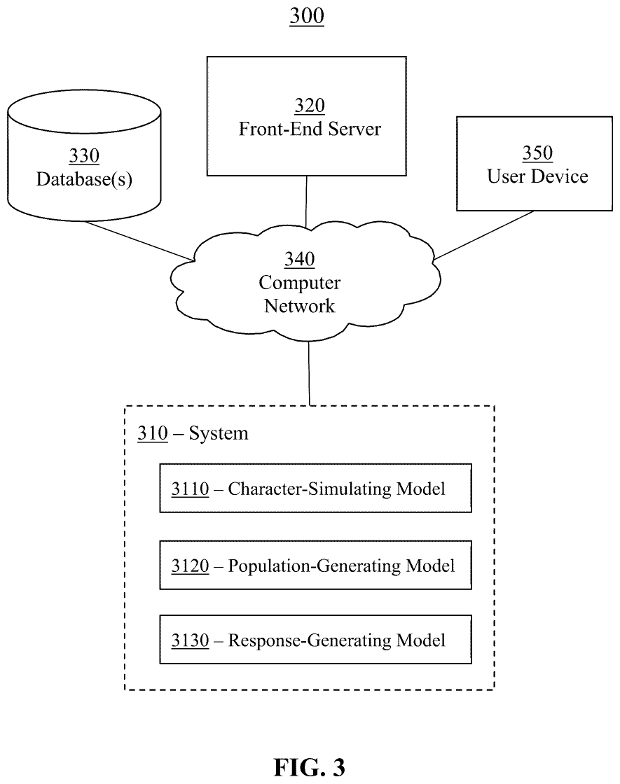

Turning ahead in the drawings, FIG. 3 illustrates a block diagram of a computer system 300 for generating and using virtual or simulated characters to synthesize a simulated population in order to simulate responses by a real-life population or target population, according to one embodiment. System 300 is exemplary, and embodiments of the system are not limited to the embodiments presented herein. The system may be employed in many different embodiments or examples not specifically depicted or described herein. In some embodiments, certain elements, modules, or systems of system 300 may perform various procedures, processes, operations, actions, and/or activities. In other embodiments, the procedures, processes, operations, actions, and/or activities may be performed by other suitable elements, modules, or systems of system 300.

Generally, therefore, system 300 may be implemented with hardware and/or software, as described herein. In some embodiments, part or all of the hardware and/or software may be conventional, while in these or other embodiments, part or all of the hardware and/or software may be customized (e.g., optimized) for implementing part or all of the functionality of system 300 described herein.

In some embodiments, system 300 may include one or more systems (e.g., a system 310), one or more front-end servers (e.g., a front-end server 320), and/or one or more user devices (e.g., a user device 350). System 310, front-end server 320, and user device 350 may each be a computer system, such as computer system 100 (FIG. 1), as described above, and may each be a single computer, a single server, or a cluster or collection of computers or servers, or a cloud of computers or servers. In another embodiment, a single computer system may host each of system 310, front-end server 320, and user device 350.

In many embodiments, system 310 may be modules of computing instructions (e.g., software modules) stored at non-transitory computer readable media that operate on one or more processors. In other embodiments, system 310 may be implemented in hardware. In many embodiments, system 310 may comprise one or more systems, subsystems, modules, models, or servers (e.g., a character-simulating model 3110, a population-generating model 3120, a response-generating model 3130, etc.). Additional details regarding system 310, front-end server 320, and/or user device 350 are described herein.

In some embodiments, system 310 may be in data communication, through a computer network, a telephone network, or the Internet (e.g., computer network 340), with front-end server 320, and/or user device 350. In some embodiments, user device 350 may be used by users, such as users for system 310 and/or front-end server 320 (e.g., a data scientist, a machine learning engineer, a system engineer, an insurance agent, a financial analyst, or an insurance underwriter, etc.).

In certain embodiments, system 310 and/or front-end server 320 may host one or more websites and/or mobile application servers. For example, system 310 and/or front-end server 320 may host a website, or provide a server that interfaces with an application (e.g., a mobile application or a web browser), on user device 350, which may allow users to configure, train, or manage character-simulating model 3110, population-generating model 3120, and/or response-generating model 3130, to inquire or interact with response-generating model 3130, in addition to other suitable activities. In some embodiments, an internal network (e.g., computer network 340) that is not open to the public may be used for communications between system 310 and front-end server 320 and/or user device 350 within system 300.

In certain embodiments, the user devices (e.g., user device 350) may be a mobile device, and/or other endpoint devices used by one or more users. A mobile device may refer to a portable electronic device (e.g., an electronic device easily conveyable by hand by a person of average size) with the capability to present audio and/or visual data (e.g., text, images, videos, music, etc.). For example, a mobile device may include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, an augmented-reality (AR) headset, a virtual-reality (VR) headset, etc.), or another portable computer device with the capability to present audio and/or visual data (e.g., images, videos, music, etc.).

Thus, in many examples, a mobile device may include a volume and/or weight sufficiently small as to permit the mobile device to be easily conveyable by hand. For examples, in some embodiments, a mobile device may occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device may weigh less than or equal to 15.6 Newtons, 17.8 Newtons, 22.3 Newtons, 31.2 Newtons, and/or 44.5 Newtons.

Exemplary mobile devices may include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Mayada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device may include an electronic device configured to implement one or more of (i) the iPhone® operating system by Apple Inc. of Cupertino, California, United States of America, (ii) the Blackberry® operating system by Research In Motion (RIM) of Waterloo, Ontario, Mayada, (iii) the Android™ operating system developed by the Open Handset Alliance, or (iv) the Windows Mobile™ operating system by Microsoft Corp. of Redmond, Washington, United States of America.

In many embodiments, system 310 may include one or more input devices (e.g., one or more keyboards, one or more keypads, one or more pointing devices such as a computer mouse or computer mice, one or more touchscreen displays, a microphone, etc.), and/or may comprise one or more display devices (e.g., one or more monitors, one or more touch screen displays, projectors, etc.). In these or other embodiments, one or more of the input device(s) may be similar or identical to keyboard 104 (FIG. 1) and/or a mouse 110 (FIG. 1). Further, one or more of the display device(s) may be similar or identical to monitor 106 (FIG. 1) and/or screen 108 (FIG. 1).

The input device(s) and the display device(s) may be coupled to system 310 in a wired manner and/or a wireless manner, and the coupling may be direct and/or indirect, as well as locally and/or remotely. As an example of an indirect manner (which may or may not also be a remote manner), a keyboard-video-mouse (KVM) switch may be used to couple the input device(s) and the display device(s) to the processor(s) and/or the memory storage unit(s). In some embodiments, the KVM switch also may be part of system 310. In a similar manner, the processors and/or the non-transitory computer-readable media may be local and/or remote to each other.

Meanwhile, in many embodiments, system 310 also may be configured to communicate with one or more databases (e.g., a database(s) 330). The one or more databases may include a member database that contains information about the demographic and/or psychographic information of members of a real-life population (e.g., the population of the United States and/or Western Europe, a scholarship committee for reviewing scholarship applications, insurance policyholders for an insurance company, existing and/or potential customers for a retailer, owners of vehicles manufactured by an automobile manufacture, members of a target market, etc.). The demographic and/or psychographic information of the members may include the ages, genders, hobbies, resident countries, resident states, resident cities, insurance policies, premiums, and/or claim histories for the members, for example, among other information. The one or more databases additionally may include one or more of the trained machine learning (ML) and/or artificial intelligence (AI) models (the ML/AI models) used in system 300 and/or system 310. The one or more databases further may include training datasets for various ML/AI models, modules, or systems, including character-simulating model 3110, population-generating model 3120, and/or response-generating model 3130, etc. The training datasets may be obtained from a third party, generated manually, and/or curated from historical input/output data of one or more pre-trained ML/AI models, etc.

The one or more databases may be stored on one or more memory storage units (e.g., non-transitory computer readable media), which may be similar or identical to the one or more memory storage units (e.g., non-transitory computer readable media) described above with respect to computer system 100 (FIG. 1). Also, in some embodiments, for any particular database of the one or more databases, that particular database may be stored on a single memory storage unit or the contents of that particular database may be spread across multiple ones of the memory storage units storing the one or more databases, depending on the size of the particular database and/or the storage capacity of the memory storage units.

The one or more databases may each include a structured (e.g., indexed) collection of data and may be managed by any suitable database management systems configured to define, create, query, organize, update, and manage database(s). Exemplary database management systems may include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or the one or more databases (e.g., database(s) 330) may be implemented using any suitable manner of wired and/or wireless communication. Accordingly, system 300 and/or system 310 may include any software and/or hardware components configured to implement the wired and/or wireless communication. Further, the wired and/or wireless communication may be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) may include Bluetooth, Zigbee, Wireless Universal Serial Bus (USB), Z-Wave, etc.; exemplary LAN and/or WAN protocol(s) may include Institute of Electrical and Electronic Engineers (IEEE) 802.3 (also known as Ethernet), IEEE 802.11 (also known as WiFi), etc.; and exemplary wireless cellular network protocol(s) may include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented may depend on the network topologies and/or protocols implemented, and vice versa. In many embodiments, exemplary communication hardware may include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware may include wireless communication hardware including, for example, one or more radio transceivers, one or more infrared transceivers, etc. Additional exemplary communication hardware may include one or more networking components (e.g., modulator-demodulator components, gateway components, etc.).

In many embodiments, system 310 may be configured to receive, via a user device (e.g., user device 350, computer system 100 (FIG. 1), etc.), an inquiry input from a user (e.g., an insurance agent, a financial analyst, or an insurance underwriter, etc.). The inquiry input may be associated with an inquiry and one or more known-member characteristic values for one or more known members of a real-life population. In similar or different embodiments, system 310 may receive the inquiry and the one or more known-member characteristic values in multiple inquiry inputs separately.

For example, an inquiry input of “will a reduction of 1% premium or an increase in a premium discount for auto insurance policies next year affect the renewal decisions by the female policy holders in California” may be associated with an inquiry of whether the reduction of 1% premium or the increase in a premium discount for this auto insurance policy next year affect a renewal decision and the known-member characteristic values that include the characteristics of the female auto insurance policy holders who reside in in California. Another exemplary inquiry input of “how many of the 50 employees of company X will attend the holiday party on December 9?” may be associated with an inquiry concerning the decision to attend the holiday party on December 9 and the known-member characteristic values that include the characteristics of the 31 female employees and 19 male employees of company X.

In some embodiments, system 310 further may be configured to use a trained natural language processing (NLP) model (e.g., BERT, XLNet, Generative Pre-trained Transformer (GPT) 3, GPT-4, etc.), or apply an NLP algorithm, to determine the inquiry and the one or more known-member characteristic values for one or more known members associated with the inquiry input, as received. In similar or different embodiments, the inquiry and the one or more known-member characteristic values for one or more known members associated with the inquiry input may be entered one by one by the user via an application (e.g., a mobile application or a web browser) with input controls (e.g., text boxes, drop-down menus, etc.) for respective known-member characteristics.

In many embodiments, system 310 further may be configured to determine simulated characters for population groups for the real-life population. In some embodiments, the simulated characters may be pre-determined and retrieved, from a database (e.g., database(s) 330), by system 310 or character-simulating model 3110. In similar or different embodiments, system 310 may generate the simulated characters by a trained character-simulating model (e.g., character-simulating model 3110, a trained linear regression model, a K-Nearest-Neighbors (KNN) model, a decision-tree-based model, a K-Means model, a neural-network model, etc.) based upon member characteristics for the population groups.

In certain embodiments, the population groups may be associated with member characteristics (e.g., an age range, a city, a state, a country, a gender, a race, a type of occupation, a marital status, a highest education received, an annual income range, health/auto insurance status, etc.). The population groups further may be generated based upon or defined by one or more selected ones (e.g., a gender, an age range and a state, etc.) of the member characteristics. The member characteristics and/or the one or more selected ones of the member characteristics for generating the population groups may be determined or selected manually or automatically by any suitable systems and/or models (e.g., system 300, system 310, character-simulating model 3110, a classification ML model, etc.). For example, system 310 may receive, via a user device (e.g., user device 350, computer system 100 (FIG. 1), etc.) from a user (e.g., a data scientist, a machine learning engineer, a system engineer, etc.), the member characteristics for the population groups. Further, system 310 and/or character-simulating model 3110 may use any suitable ML models (e.g., a classification ML model, logistic regression models, Naïve Bayes models, neural network models, decision-tree models, etc.), to generate the population groups.

In various embodiments, the population groups, as generated, may be mutually exclusive or partly overlap. For example, the population groups generated based upon a combination of the member characteristics (e.g., age ranges and resident states) may be mutually exclusive. In another example, the population groups may be generated based upon various combinations of the member characteristics (e.g., genders, genders and occupation types, resident states and age ranges, etc.), and some of the population groups (e.g., U.S. male population, male high school students, and Arizona teenagers) may overlap, at least in part, and have one or more common group members (e.g., a 15-year-old male high school student living in Phoenix, Arizona).

In several embodiments, each of the simulated characters, as determined, may be associated with, or representative of, one of the population groups. Further, each of the simulated characters may be associated with the member characteristics for the one of the population groups.

In certain embodiments, each population group may be associated with a single simulated character. For example, a simulated character associated with a population group of female Texas lawyers at the age range of 40-49 may be associated with characteristic values generated by system 310 for the member characteristics, including the values for the one or more selected one of the member characteristics (e.g., the age of 42, the gender of female, the state of Texas, and the occupation of lawyer) and values for the other member characteristics (e.g., the city of Dallas, the marital status of married, etc.).

In several embodiments, the population groups and/or the simulated characters, as determined, may be stored in a database (e.g., database(s) 330) or a storage device (e.g., memory storage unit 208 (FIG. 2), hard drive 114 (FIGS. 1-2), CD-ROM and/or DVD drive 116 (FIGS. 1-2), a USB drive in USB port 112 (FIGS. 1-2), etc.) and retrieved for use later. In similar or different embodiments, the population groups and/or the simulated characters may be generated periodically (e.g., every 2 weeks, every 3 months, every 6 months, etc.) or dynamically every time the population groups and/or the simulated characters are needed.

In many embodiments, system 310 further may be configured to determine one or more matched simulated (or virtual) characters of the simulated (or virtual) characters for the one or more known members based upon the one or more known-member characteristic values. System 310 may use any suitable algorithms or techniques (e.g., fuzzy matching, a Convolutional-Neural-Networks (CNN) model, etc.) to determine the one or more matched simulated characters for the one or more known members. In some embodiments, the respective characteristic values for each matched simulated character may be different, similar, or identical to the one or more known-member characteristic values for a corresponding known member. For example, a matched simulated character for a known member who is a 42-year-old female Colorado high-school teacher may be a 45-year-old female Colorado elementary-school teacher.

In many embodiments, system 310 also may be configured to determine a simulated population for the real-life population based upon the one or more matched simulated characters, as determined. System 310 may use any suitable techniques, models, and/or systems (e.g., population-generating model 3120, a trained population-generating model, etc.) to generate the simulated population based upon the one or more matched simulated characters. Examples of trained ML models or algorithms for system 310 and/or population-generating model 3120 to generate the simulated population may include Generative Adversarial Networks (GANs), CTGAN, CNNs, Variational Autoencoders (VAEs), etc.

In several embodiments, population-generating model 3120 may: (a) before determining the simulated population, determine one or more characteristic variations for the one or more matched simulated characters; and/or (b) determine the simulated population based upon the one or more matched simulated characters (e.g., their respective characteristic values, such as ages, resident states, occupation types, income ranges, etc.) and the one or more characteristic variations, relative to the one or more known-member characteristic values. The one or more characteristic variations may be determined by: (a) retrieving, from a database (e.g., database(s) 330); (b) receiving, via a user device from a user, the one or more characteristic variations; and/or (c) determining the one or more respective characteristic variations based upon respective statistics data for the member characteristics for each population group (e.g., the sum, mean, medium, standard deviation, and/or distribution of each member characteristic, such as age, life span, education degree, weight, etc.). The user may be the same user or a different user from the user who inputs the inquiry input and/or determines the member characters, etc. The quantity of the one or more characteristic variations may be equal to or fewer than the quantity of the one or more known-member characteristic values.

For example, the one or more characteristic variations for a matched simulated character generated based upon a 43-year-old male Nevada lawyer with an annual income of U.S. $320,000 may include an age variation of ±3 and an annual income variation including an income range for U.S. $320,000 (e.g., U.S. $300,000-$350,000), but no variations for genders, occupation types, and resident states. The matched simulated character, as generated, may be a 41-year-old male Nevada lawyer with an annual income of U.S. $305,000.

In many embodiments, system 310 further may be configured to generate one or more simulated responses to the inquiry for the one or more known members based upon the simulated population, as determined. System 310 may use response-generating model 3130 to generate the one or more simulated responses (e.g., answers to the inquiry associated with the inquiry input, reasons for the answers, and/or recommendations to the user). Response-generating model 3130 may include any suitable trained ML models (e.g., Large Language Model (LLMs), BERT, GPT-3, Lambda, Palm, etc.). In many embodiments, system 310 further may be configured to transmit the one or more simulated responses, as generated, to be displayed on an application (e.g., a mobile application, a web browser, etc.) executed on the user device.

System 300 and/or system 310 further may be configured to perform one or more additional or alternate operations, actions, and/or activities or use additional or alternate systems or models to perform one or more operations, actions, and/or activities. In some embodiments, to generate the simulated characters, system 310 may retrieve or sample, from a member database (e.g., database(s) 330), a model population for the real-life population. The model population, as retrieved or sampled, may include some or all of the members of the real-life population (e.g., the U.S. population, or the scholarship committee, etc.), such as all or some of the insured of an auto insurance company, the patients of a hospital, the users of an online retailer, the employees of a company, the faculty and staff of a school, etc. In certain embodiments, the model population may include none of the members of the real-life population. The member database may contain information about the demographic and/or psychographic information of the members.

In certain embodiments where the model population includes all or some of the U.S. policyholders of homeowners insurance, the member database may contain member information such as names, ages, genders, occupations, resident addresses, hobbies, religions, insurance policies, premiums, and/or claim histories for the members. System 310 may retrieve or sample the model population based upon the member characteristics for the population groups. In similar or different embodiments, system 310 further may generate the simulated characters based upon the model population, in addition to the member characteristics, as discussed above. System 310 further may determine the simulated population based upon the model population, in addition to the one or more matched simulated characters.

Further, system 300 and/or system 310 further may be configured to train or re-train one or more of the abovementioned trained ML/AI models (e.g., character-simulating model 3110, population-generating model 3120, response-generating model 3130, etc.). System 300 and/or system 310 may train the one or more ML/AI models based upon commercial training datasets by third parties, historical input/output data of the ML/AI model(s) used by system 300 and/or system 310, and/or training data curated by a user (e.g., a data scientist, an ML engineer, etc.). System 300 and/or system 310 may train the one or more ML/AI models periodically.

### Exemplary Embodiments for Generating Responses Using Simulated Characters & Simulated Population

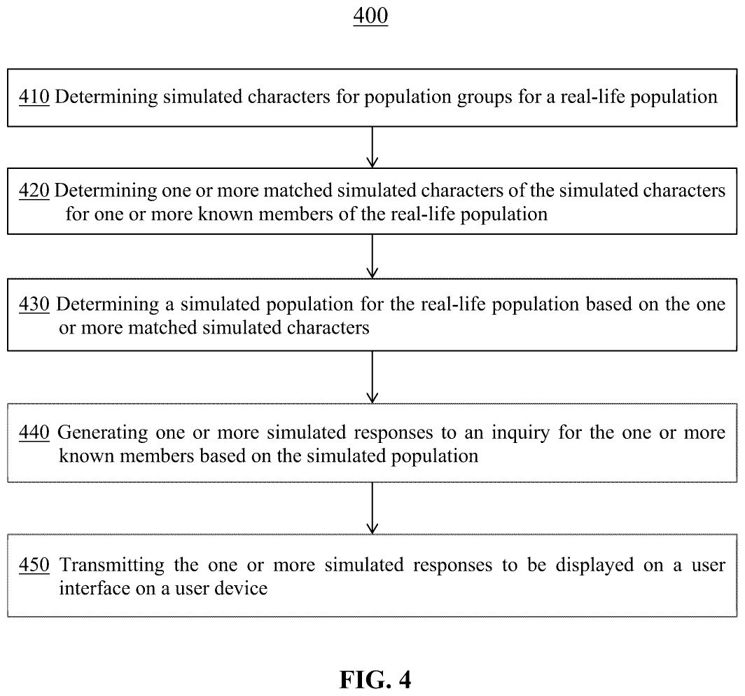

Turning ahead in the drawings, FIG. 4 illustrates actions of a computer-implemented method 400 for generating and using virtual or simulated characters to synthesize a simulated population in order to simulate responses by a population, according to certain embodiments. The method 400 is exemplary and is not limited to the embodiments presented herein. The method 400 may be employed in many different embodiments or examples not specifically depicted or described herein.

In some embodiments, the procedures, the processes, the operations, the actions, and/or the activities of method 400 may be performed in the order presented. In other embodiments, the procedures, the processes, the operations, the actions, and/or the activities of method 400 may be performed in any suitable order. In still other embodiments, one or more of the procedures, the processes, the operations, the actions, and/or the activities of method 400 may be combined or skipped.

In many embodiments, system 300 or system 310 (FIG. 3) (including one or more of its elements, modules, and/or systems, such as character-simulating model 3110, population-generating model 3120, response-generating model 3130, etc.) may be suitable to perform method 400 and/or one or more of the operations, actions, and/or activities of method 400. In these or other embodiments, one or more of the operations, actions, and/or activities of method 400 may be implemented as one or more computing instructions configured to run at one or more processors and configured to be stored at one or more non-transitory computer readable media. Such non-transitory computer readable media may be part of a computer system such as system 300 or system 310. The processor(s) may be similar or identical to the processor(s) described above with respect to computer system 100 (FIG. 1).

Referring to FIG. 4, in many embodiments, computer-implemented method 400 may include a block 410 of determining simulated characters for population groups for a real-life population based upon member characteristics for the population groups. Examples of the real-life population may include insurance policyholders for an insurance company; customers of an insurance provider, a bank, a retailer, a merchant, vehicle manufacturer, a home manufacturer, or other services or product provider; homeowners; owners of vehicles manufactured by an automobile manufacture; and/or members of a target market. The member characteristics for the population groups may be received, via a user device from a user. Each of the simulated characters may be associated with: (a) one of the population groups (e.g., New Mexico residents, male policyholders aged between 35 and 45, etc.), and (b) respective characteristic values (e.g., age=31; gender=female; state=Maine; etc.) corresponding to the member characteristics for the associated population group. Block 410 may retrieve, from a member database (e.g., database(s) 330 (FIG. 3)), a model population for the real-life population and use the model population, as retrieved, to determine the simulated characters.

In similar or different embodiments, block 410 may generate the simulated characters by a trained character-simulating model (e.g., character-simulating model 3110 (FIG. 3)), based upon the member characteristics for the population groups. Examples of the trained character-simulating model may include a linear regression model, a KNN model, a decision-tree-based model, a K-Means model, a neural-network model, etc. The trained character-simulating model may be pre-trained and retrained based upon training datasets regularly updated.

In many embodiments, the computer-implemented method further may include a block 420 of determining one or more matched simulated characters of the simulated characters for one or more known members of the real-life population based upon one or more known-member characteristic values associated with the one or more known members. Block 420 may include any suitable algorithms and/or models for matching the one or more matched simulated characters to the one or more known members.

In many embodiments, the computer-implemented method 400 also may include a block 430 of determining a simulated population for the real-life population based upon the one or more matched simulated characters, as determined. In some embodiments, block 430 may include determining one or more characteristic variations for the respective characteristic values for the one or more matched simulated characters, and then block 430 may determine the simulated population further based upon the one or more characteristic variations. In certain embodiments, block 430 additionally or alternatively may include determining the simulated population by a trained population-generating model (e.g., population-generating model 3120 (FIG. 3), a GAN model, a VAE model, etc.) based upon the one or more matched simulated characters.

In many embodiments, the computer-implemented method 400 additionally may include a block 440 of generating one or more simulated responses to an inquiry for the one or more known members based upon the simulated population, as determined. The inquiry may be associated with an inquiry input from a user that is received, via the user device. The inquiry input further may be associated with the one or more known-member characteristic values for the one or more known members of the real-life population. The one or more simulated responses may include answers and at least one of: reasons for the answers or recommendations to the user. In some exemplary embodiments, block 440 may generate the one or more simulated responses by a trained response-generating model (e.g., response-generating model 3130 (FIG. 3), an LLM model, a GPT-3 model, etc.). In many embodiments, the method further may include a block 450 of transmitting the one or more simulated responses, as generated, to be displayed on a user interface executed on a user device.

In many embodiments, the computer-implemented method 400 may include additional operations, actions, and/or activities. For example, after transmitting the one or more simulated responses in block 450, method 400 further may include receiving, from a user device (e.g., user device 350 (FIG. 3)), user feedback for the one or more simulated responses.

When the trained character-simulating model is used in block 410, the computer-implemented method 400 further may include re-training the trained character-simulating model based upon the simulated population, as determined in block 410, and user feedback received from the user device. When the trained population-generating model is used in block 430, method 400 also may include re-training the trained population-generating model based upon the simulated population, as determined in block 430, and user feedback received from the user device. When the trained response-generating model is used in block 440, method 400 further may include re-training the trained response-generating model based upon the one or more simulated responses, as determined in block 440, and the user feedback, as received.

For each of the machine learning models to be retrained, the respective training datasets may be updated manually by a user (e.g., an ML engineer, a data scientist, etc.) and/or automatically by a system (e.g., system 300 or 310 (FIG. 3)). The user may select new training data from various data sources (e.g., websites, books, magazines, product catalogs, private third-party databases, etc.). The system may collect new training data based upon various criteria. In certain embodiments, historical input and/or output data of the model to be re-trained (e.g., the trained character-simulating model in block 410, the trained population-generating model in block 430, and/or the trained response-generating model in block 440) may be used for re-training the model. In several embodiments, the historical input and/or output data of the model may be selected based upon user feedback associated with the historical output data. Examples of the user feedback may include a positive or negative review, a score from one to five, a follow-up action (e.g., an adoption of the proposed insurance premium adjustment in the inquiry, driving behavior changes as indicated by vehicle telematics data tracked by sensors on a driver's mobile devices or other devices, etc.), and so forth.

### Exemplary Computer-Implemented Methods for Simulating Responses by a Real-Life Population

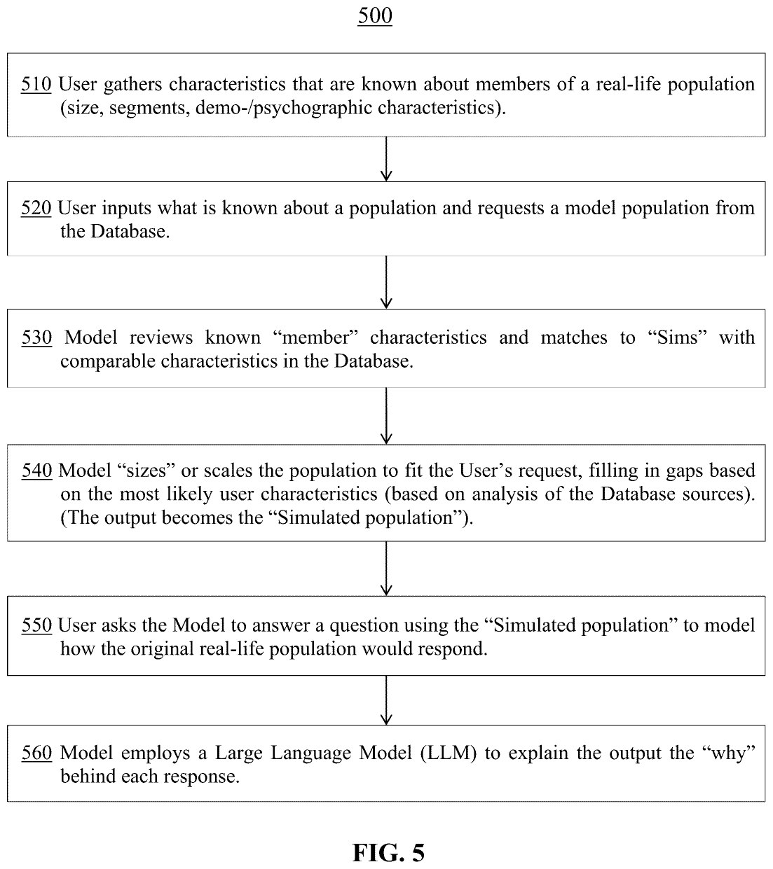

Turning ahead in the drawings, FIG. 5 illustrates actions of a computer-implemented method 500 for generating and using virtual or simulated characters to synthesize a simulated population in order to simulate responses by a population, according to some embodiments. The computer-implemented method 500 is exemplary and is not limited to the embodiments presented herein. The computer-implemented method 500 may be employed in many different embodiments or examples not specifically depicted or described herein.

In some embodiments, the procedures, the processes, the operations, the actions, and/or the activities of computer-implemented method 500 may be performed in the order presented. In other embodiments, the procedures, the processes, the operations, the actions, and/or the activities of computer-implemented method 500 may be performed in any suitable order. In still other embodiments, one or more of the procedures, the processes, the operations, the actions, and/or the activities of computer-implemented method 500 may be combined or skipped. In many embodiments, method 500 may be similar or identical to method 400 (FIG. 4), and some or all of the procedures, the processes, the operations, the actions, and/or the activities of method 500 may be similar or identical to the procedures, the processes, the operations, the actions, and/or the activities of method 400.

In many embodiments, the computer system 300 or system 310 (FIG. 3) (including one or more of its elements, modules, and/or systems, such as character-simulating model 3110, population-generating model 3120, response-generating model 3130, etc.) may be suitable to perform method 500 and/or one or more of the operations, actions, and/or activities of method 500. In these or other embodiments, one or more of the operations, actions, and/or activities of method 500 may be implemented as one or more computing instructions configured to run at one or more processors and configured to be stored at one or more non-transitory computer readable media. Such non-transitory computer readable media may be part of a computer system such as system 300 or system 310. The processor(s) may be similar or identical to the processor(s) described above with respect to computer system 100 (FIG. 1).

Referring to FIG. 5, in many embodiments, computer-implemented method 500 may include a block 510 of receiving, via a user device (e.g., user device 350 (FIG. 3), computer system 100 (FIG. 1), etc.) for a user (e.g., an insurance agent, a marketing manager, etc.), characteristics that are known about members of a real-life population (e.g., size, segments, demo-/psychographic characteristics, etc.). In different or similar embodiments, block 510 may retrieve the characteristics from a database (e.g., database(s) 330). The characteristics may include one or more known-member characteristic values for the one or more known members. Exemplary known-members may include a 42-year-old male Texas resident who is a lawyer, a 19-year old male Michigan resident who is a student, a 54-year-old female Colorado resident who is a federal employee, and so forth. Exemplary characteristics may include genders, ages, resident states, occupations, etc. In similar or different embodiments, in addition to the one or more known-member characteristic values for one or more known members of the real-life population, block 510 may include receiving, via the user device, an inquiry of an inquiry input from a user.

In certain embodiments, block 520 further may include: before receiving inputs (e.g., the characteristics about the members and/or the inquiry) from the user, providing an application (e.g., a mobile application, a web browser, etc.) executed on the user device. The application may include any suitable user input controls for receiving user inputs and/or commands, such as one or more pre-defined user controls for the characteristics (e.g., a drop-down list of the U.S. states/cities or occupations, a text box for the street address, a checkbox for a marital status, etc.), a single free-form input text box to receive a description of a member, a button to cause computer-implemented method 500 to perform an activity, action, and/or operation).

In many embodiments, the computer-implemented method 500 may include a block 520 of allowing a user to input what is known about the real-life population and request a model population from a database (e.g., database(s) 330 (FIG. 3), a member database, etc.). The user may be the same user as in block 410 (FIG. 4) or a different user. Further, the model population may include one or more of the members in block 410. In certain embodiments, the model population may include none of the members in block 510.

In some embodiments, the input from the user (e.g., what is known about the real-life population) may include member characteristics for one or more population groups for the real-life population. In addition, after the characteristics of the known members are received in block 510, the user may analyze the known-member characteristic values and associate one or more population groups with one or more member characteristics. For example, a first population group may be associated with a first member characteristic (e.g., gender=male), a second population group may be associated with a second member characteristic (e.g., age=42), a third population group may be associated with third member characteristics (e.g., resident state=Colorado and gender=female), and so forth.

In certain embodiments, upon receiving the user's request for the model population, block 520 may determine the model population based upon the member characteristics the user provides. For example, the model population may include the first population group, the second population group, and the third population group, as in the example above.

In many embodiments, the computer-implemented method 500 further may include a block 530 of reviewing the known-member characteristics and matching the known members to simulated characters (e.g., the “Sims”) with comparable characteristics in the database (e.g., database(s) 330 (FIG. 3), the member database, etc.). Block 530 may be performed manually by a user or automatically by a system or model (e.g., system 300, system 310, or character-simulating model 3110 (FIG. 3)). In certain embodiments, before matching the known members to the simulated characters, block 530 further may include determining the simulated characters for the population groups for the real-life population based upon the member characteristics for the population groups, as determined in block 520. Each simulated character may be associated with one of the population groups. Additionally, each simulated character may be associated with respective characteristic values for the member characteristics for the one of the population groups.

In several embodiments, determining the simulated characters in block 530 further may include: (a) retrieving, from a member database (e.g., database(s) 330 (FIG. 3)), the model population for the real-life population based upon the member characteristics (e.g., block 520); and/or (b) generating the simulated characters further based upon the model population, in addition to the member characteristics for the population groups. In some embodiments, generating the simulated characters in block 530 further may include generating the simulated characters by a trained character-simulating model (e.g., character-simulating model 3110 (FIG. 3), a logistic regression model, a Naïve Bayes model, a neural network model, etc.) based upon the member characteristics for the population groups.

In certain embodiments, matching the known members to the simulated characters in block 530 may include determining one or more matched simulated characters of the simulated characters for the known members based upon the one or more known-member characteristic values. In some embodiments, block 530 may determine that a simulated character matches a known member when the respective characteristic values associated with the simulated character are identical or substantially similar (e.g., 60%, 75%, or 80% identical) to the known-member characteristic values associated with the known member. In similar or different embodiments, block 530 may include any suitable algorithms or techniques (e.g., fuzzy matching, a CNN model, etc.) for determining the one or more matched simulated characters.

In many embodiments, the computer-implemented method 500 further may include a block 540 of sizing or scaling the population to fit the user's request (to become a simulated population), filling in the gaps based upon the most likely user characteristics (based upon analysis of the database sources). Block 540 may use any suitable techniques, systems, or models (e.g., computer system 300, system 310, population-generating model 3120 (FIG. 3), statistics-based models, a GAN model, a VAE model, etc.) or manually to generate the simulated population.

In several embodiments, the simulated population for the real-life population may be determined in block 540 based upon one or more of: (a) the one or more matched simulated characters, as determined in block 530; (b) the model population, as determined in block 520; and/or (c) one or more characteristic variations for the respective characteristic values for the one or more matched simulated characters. In certain embodiments, block 540 further may include: before determining the simulated population, determining the one or more characteristic variations for the respective characteristic values for the one or more matched simulated characters.

In many embodiments, the computer-implemented method 500 further may include a block 550 of receiving, from a user device, the inquiry and generating a respective answer or response to the inquiry for each known member, as determined in block 510, based upon each simulated member of the simulated population, as determined in block 540. In some embodiments, the respective answer for each simulated member may include one or more respective potential answers and the respective probability for each of the one or more respective potential answers. For example, the answer generated for the first simulated character (Sim 1) may include the potential response X with a 55% probability and the potential response Y with a 45% probability; the answer generated for the second simulated character (Sim 2) may include the potential response X with a 90% probability, the potential response Y with a 5% probability, and the potential response Z with a 5% probability; the answer generated for the third simulated character (Sim 3) may include the potential response X with a 60% probability, the potential response Y with a 25% probability, and the potential response Z with a 15% probability; and so forth.

In many embodiments, the computer-implemented method 500 further may include a block 560 of using a Large Language Model (LLM) (e.g., system 300, system 310, response-generating model 3130 (FIG. 3), a BERT model, a GPT-4 model, etc.) trained to determine a respective explanation or reason for the respective answer. For example, the respective reason for the answer/response by Sim 1, as determined in block 550, may be that “members like Sim 1 are undecided about this topic”; the respective reason for the answer/response by Sim 2, as determined in block 550, may be that “members like Sim 2 are very passionate about this topic, unless they are unemployed or independently wealthy”; and the respective reason for the answer/response by Sim 3, as determined in block 550, may be that “members like Sim 3 generally feel a deep connection to the government unless they are new employees”, etc. In certain embodiments, method 500 additionally may include generating, via the LLM used in block 560, system 300, system 310, or response-generating model 3130, one or more respective recommendations associated the respective answer for each simulated member representative of each known member.

In many embodiments, the computer-implemented method 500 further may include transmitting the one or more simulated responses, including the answers, reasons, and/or recommendations as determined in blocks 550 and 560, to be displayed on a user interface executed on the user device.

### Exemplary Computer-Implemented Methods for Simulating Real-Life Responses

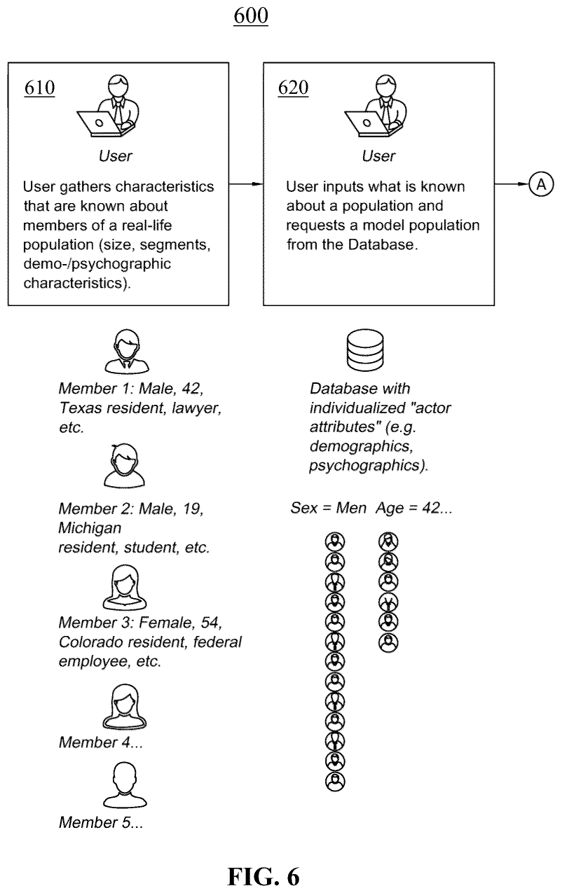

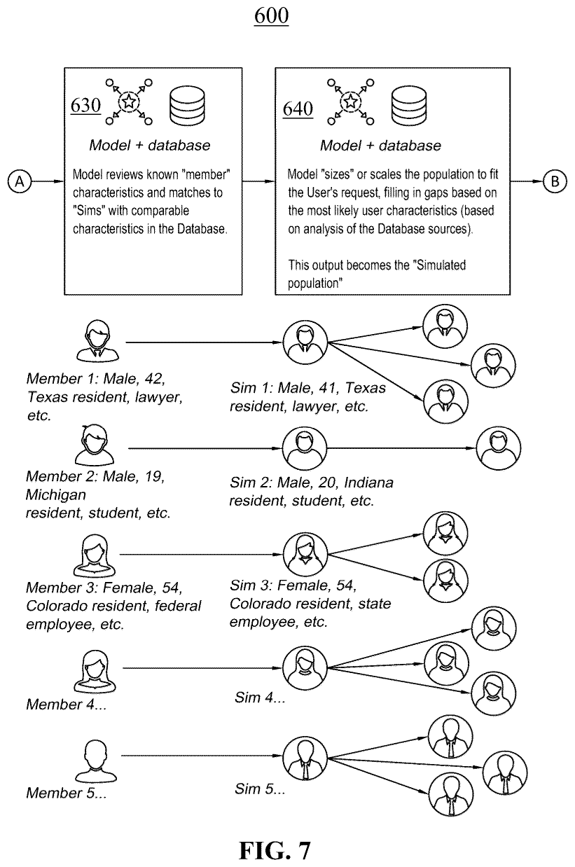

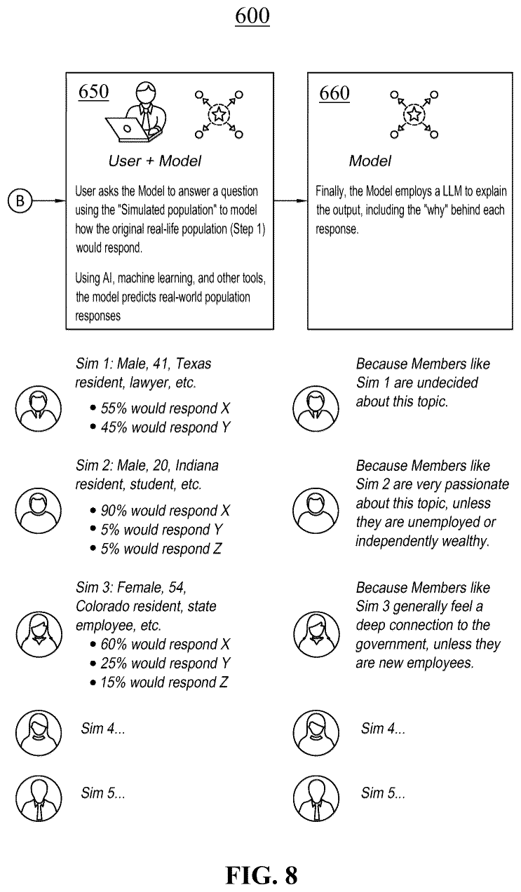

Turning ahead in the drawings, FIGS. 6-8 illustrate actions of an exemplary computer-implemented method 600 for simulating real-life responses by a population, according to some embodiments. The computer-implemented method 600 is exemplary and is not limited to the embodiments presented herein. The computer-implemented method 600 may be employed in many different embodiments or examples not specifically depicted or described herein.

In some embodiments, the procedures, the processes, the operations, the actions, and/or the activities of computer-implemented method 600 may be performed in the order presented. In other embodiments, the procedures, the processes, the operations, the actions, and/or the activities of computer-implemented method 600 may be performed in any suitable order. In still other embodiments, one or more of the procedures, the processes, the operations, the actions, and/or the activities of computer-implemented method 600 may be combined or skipped. In many embodiments, method 600 may be similar or identical to method 400 (FIG. 4) and/or method 500 (FIG. 5), and some or all of the procedures, the processes, the operations, the actions, and/or the activities of method 600 may be similar or identical to the procedures, the processes, the operations, the actions, and/or the activities of method 400 and/or method 500.

In many embodiments, the computer system 300 or system 310 (FIG. 3) (including one or more of its elements, modules, and/or systems, such as character-simulating model 3110, population-generating model 3120, response-generating model 3130, etc.) may be suitable to perform method 600 and/or one or more of the operations, actions, and/or activities of method 600. In these or other embodiments, one or more of the operations, actions, and/or activities of method 600 may be implemented as one or more computing instructions configured to run at one or more processors and configured to be stored at one or more non-transitory computer readable media. Such non-transitory computer readable media may be part of a computer system such as system 300 or system 310. The processor(s) may be similar or identical to the processor(s) described above with respect to computer system 100 (FIG. 1).

Referring to FIG. 6, in many embodiments, computer-implemented method 600 may include a block 610 of allowing a user to gather characteristics that are known about members of a real-life population. Block 610 may be similar or identical to block 510 (FIG. 5). The characteristics may be stored in and gathered from a database (e.g., database(s) 330 (FIG. 3)). Exemplary known-members may include a 42-year-old male Texas resident who is a lawyer, a 19-year-old male Michigan resident who is a student, a 54-year-old female Colorado resident who is a federal employee, and so forth. The characteristics may include the characteristics of the real-life population that are common among the known members (e.g., size, segments, demo-/psychographic characteristics, etc.) and/or the one or more known-member characteristic values for the one or more known members (e.g., genders, ages, resident states, occupations, etc.).

In many embodiments, the computer-implemented method 600 may include a block 620 of allowing a user to input, via a user device (e.g., user device 350 (FIG. 3)), what is known about the population and request a model population from a database (e.g., database(s) 330 (FIG. 3), a member database, etc.). Block 620 may be similar or identical to block 520 (FIG. 5). For example, the input from the user (e.g., what is known about the population) may include member characteristics for one or more population groups for the population. The known-member characteristic values may be analyzed, manually by the user or automatically by a system or a model (e.g., system 300 or system 310 (FIG. 3)), and may be used for determining a respective association between one or more population groups and one or more member characteristics accordingly. Additionally, in response to the user's request for the model population, block 620 may determine the model population based upon the member characteristics the user provides.

In many embodiments, the computer-implemented method 600 further may include a block 630 of reviewing the known-member characteristics and matching the known members to simulated characters (e.g., the “Sims”) with comparable characteristics in the database. Block 630 may be similar or identical to block 530 (FIG. 5). For example, before matching the known members to the simulated characters, block 630 further may include determining the simulated characters for the population groups for the population. Determining the simulated characters in block 630 may include: (a) retrieving, from a member database (e.g., database(s) 330 (FIG. 3)), the model population for the population based upon the member characteristics based upon the member characteristics for the population groups, as determined in block 620; and/or (b) generating the simulated characters: (i) based upon the member characteristics for the population groups and/or the model population, and/or (ii) by a trained character-simulating model (e.g., character-simulating model 3110 (FIG. 3)). Further, matching the known members to the simulated characters in block 630 may include determining one or more matched simulated characters of the simulated characters for the known members based upon the one or more known-member characteristic values.

In many embodiments, the computer-implemented method 600 further may include a block 640 of generating a simulated population by sizing or scaling the population to fit the user's request and filling in the gaps based upon the most likely user characteristics (based upon analysis of the database sources). Block 640 may be similar or identical to block 540 (FIG. 5). For example, block 640 may use any suitable techniques, systems, or models (e.g., computer system 300, system 310, population-generating model 3120 (FIG. 3), etc.) or manually to generate the simulated population. The simulated population for the population may be determined in block 640 based upon one or more of: (a) the one or more matched simulated characters, as determined in block 630; (b) the model population, as determined in block 620; and/or (c) one or more characteristic variations for the respective characteristic values for the one or more matched simulated characters. In addition, before determining the simulated population, block 640 may determine the one or more characteristic variations for the respective characteristic values for the one or more matched simulated characters.

In many embodiments, the computer-implemented method 600 further may include a block 650 of allowing a user to ask, via a user device, a question (e.g., the inquiry) and generating a respective answer or response to the inquiry for each known member, as determined in block 610, based upon each simulated member of the simulated population, as determined in block 640. Block 650 may be similar or identical to block 550 (FIG. 5). In some embodiments, the respective answer for each simulated member may include one or more respective potential answers and the respective probability for each of the one or more respective potential answers.

In many embodiments, the computer-implemented method 600 further may include a block 660 of using a Large Language Model (LLM) (e.g., system 300, system 310, response-generating model 3130 (FIG. 3), etc.) trained to determine a respective explanation or reason for the respective answer. Block 660 may be similar or identical to block 560 (FIG. 5). In a few embodiments, method 600 additionally may include generating, via the LLM used in block 560, system 300, system 310, or response-generating model 3130, one or more respective recommendations associated the respective answer for each simulated member representative of each known member.

In many embodiments, the computer-implemented method 600 further may include causing the one or more simulated responses, including the answers, reasons, and/or recommendations as determined in blocks 650 and 660, to be displayed on a user interface executed on the user device.

### Exemplary Computer-Implemented Methods for Simulating Responses by an Intellectual Property Review Board

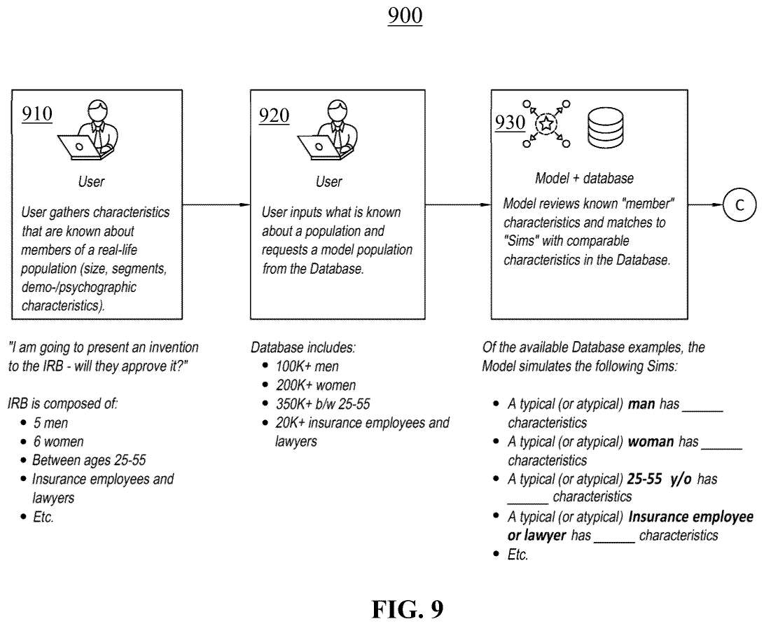

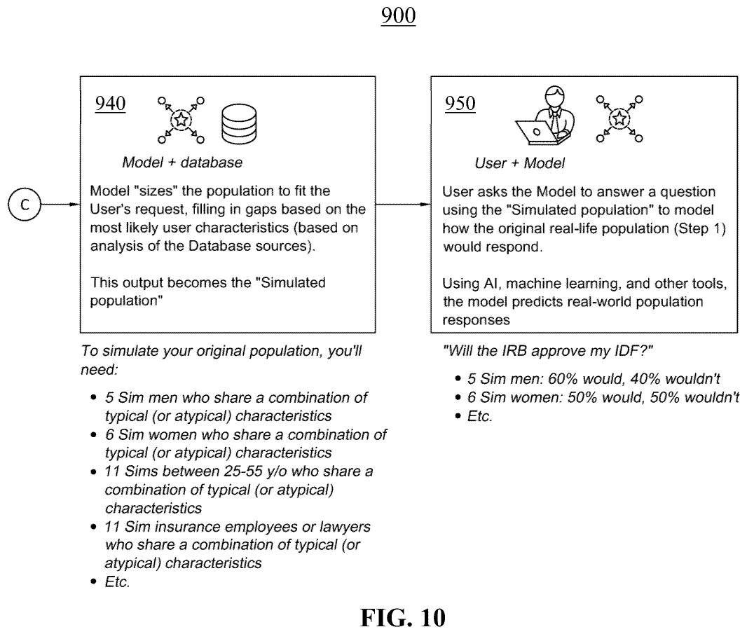

Turning ahead in the drawings, FIGS. 9-10 illustrate actions or operations of an exemplary computer-implemented method 900 for generating and using simulated characters to synthesize a simulated population in order to simulate responses by an intellectual property review board, according to some embodiments. The computer-implemented method 900 is exemplary and is not limited to the embodiments presented herein. The computer-implemented method 900 may be employed in many different embodiments or examples not specifically depicted or described herein.

In some embodiments, the procedures, the processes, the operations, the actions, and/or the activities of computer-implemented method 900 may be performed in the order presented. In other embodiments, the procedures, the processes, the operations, the actions, and/or the activities of computer-implemented method 900 may be performed in any suitable order. In still other embodiments, one or more of the procedures, the processes, the operations, the actions, and/or the activities of computer-implemented method 900 may be combined or skipped. In many embodiments, method 900 may be similar or identical to method 400 (FIG. 4), method 500 (FIG. 5), and/or method 600 (FIGS. 6-8), and some or all of the procedures, the processes, the operations, the actions, and/or the activities of method 900 may be similar or identical to the procedures, the processes, the operations, the actions, and/or the activities of method 400, method 500, and/or method 600.

In many embodiments, the computer system 300 or system 310 (FIG. 3) (including one or more of its elements, modules, and/or systems, such as character-simulating model 3110, population-generating model 3120, response-generating model 3130, etc.) may be suitable to perform method 900 and/or one or more of the operations, actions, and/or activities of method 900. In these or other embodiments, one or more of the operations, actions, and/or activities of method 900 may be implemented as one or more computing instructions configured to run at one or more processors and configured to be stored at one or more non-transitory computer readable media. Such non-transitory computer readable media may be part of a computer system such as system 300 or system 310. The processor(s) may be similar or identical to the processor(s) described above with respect to computer system 100 (FIG. 1).

Referring to FIGS. 9-10, in many embodiments, the exemplary computer-implemented method 900 may be adopted for generating and using virtual or simulated characters to synthesize a simulated population in order to simulate responses by an intellectual property review board (IRB) of a company. The computer-implemented method 900 may be similar or identical to method 400 (FIG. 4), method 500 (FIG. 5), and/or method 600 (FIGS. 6-8). The computer-implemented method 900 may include a block 910 similar or identical to block 510 and/or block 610.

Block 910 may include receiving, via a user device (e.g., user device 350 (FIG. 3), computer system 100 (FIG. 1), etc.) for a user, known-member characteristic values for one or more known members of a real-life population (e.g., size, segments, demo-/psychographic characteristics, etc.). For example, the known-members may include the IRB members (e.g., 5 men and 6 women, all being employees and/or lawyers for an insurance company, between ages 25-55, etc.). The exemplary known-member characteristic values may include genders, ages, occupations, etc.

The exemplary computer-implemented method 900 further may include a block 920 similar or identical to block 410 (FIG. 4), block 520 (FIG. 5), and/or block 630 (FIGS. 6-8). Block 920 may include allowing a user to input what is known about the IRB and request a model population from a database (e.g., database(s) 330 (FIG. 3), a member database, an employee database, etc.).

The input (e.g., what is known about the IRB) may include member characteristics associated with or defining population groups. For example, the population groups may include a first population group including at least 100,000 men (gender=male) in the database; a second population group including at least 200,000 women (gender=female) in the database; a third population group including at least 350,000 members between the ages 25-55 (25≤age≤55); a fourth population group including at least 20,000 members who are the insurance company's employees and/or lawyers (occupation=employee or lawyer and company=the insurance company), etc. The model population may include the first population group, the second population group, the third population group, and the fourth population group, as in the example above.

The exemplary computer-implemented method 900 further may include a block 930 similar or identical to block 420 (FIG. 4), block 530 (FIG. 5), and/or block 630 (FIGS. 6-8). Block 930 may include reviewing the known-member characteristics and matching the known members to simulated characters (e.g., the “Sims”) with comparable characteristics in the database (e.g., database(s) 330 (FIG. 3), the member database, the employee database, etc.). Block 930 may be performed manually by a user or automatically by a computer system or model (e.g., system 300, system 310, or character-simulating model 3110 (FIG. 3)). For example, when the IRB includes 5 male and 6 female members, the third action or operation may determine 5 male simulated characters and 6 female simulated characters to match the IRB members.

The exemplary computer-implemented method 900 further may include a block 940 similar or identical to block 430 (FIG. 4), block 540 (FIG. 5), and/or block 640 (FIGS. 6-8). Block 940 may include sizing the population to fit the user's request (to become a simulated population), filling in the gaps based upon the most likely user characteristics (based upon analysis of the database sources). Block 940 may be performed by any suitable computer systems or models (e.g., system 300, system 310, or population-generating model 3120 (FIG. 3), etc.) to generate the simulated population. Block 940 may generate the simulated population by determining the simulated population based upon one or more of: (a) the one or more matched simulated characters; (b) the model population; and/or (c) one or more characteristic variations for the respective characteristic values for the one or more matched simulated characters.

In certain embodiments, the exemplary computer-implemented method 900 further may include a block 950 similar or identical to block 440 (FIG. 4), block 550 (FIG. 5), block 650 (FIGS. 6-8). Block 950 may include receiving, from a user device, the inquiry (e.g., “Will the IRB approve my IDF?”) and generating a respective answer or response to the inquiry for each known member based upon each simulated member of the simulated population. Block 950 may be performed by any suitable systems or models (e.g., system 300, system 310, response-generating model 3130 (FIG. 3), etc.) to receive the inquiry and/or generate the respective answer. In some embodiments, for the five male simulated characters, 60% of the answers may be positive and 40% of the answers may be negative; for the six female simulated characters, 50% of the answers may be positive and 50% of the answers may be negative; and so forth.

In addition, the exemplary computer-implemented method 900 may include an additional block (e.g., a sixth action or operation, not shown) similar or identical to block 560 (FIG. 5) and/or block 660 (FIGS. 6-8). The sixth action or operation may include using a Large Language Model (LLM) (e.g., system 300, system 310, or response-generating model 3130 (FIG. 3)) trained to determine a respective explanation or reason for the respective answer. For example, the respective reason for an answer/response, as determined in the sixth activity, action, or operation for the IRB members, may be: “It's an OK idea, and those who are most like you may be more inclined to support it.”

Further, the exemplary computer-implemented method 900 may include another additional block (e.g., a seventh action or operation, not shown) similar or identical to block 450 (FIG. 4). The seventh action or operation may include transmitting, via a computer network (e.g., computer network 340), the simulated responses (including the responses determined in block 950 and the explanations determined in the sixth action or operation) to be displayed on a user interface executed on a user device (e.g., user device 350 (FIG. 3)). The user may be the same or different user who inputs what is known about the IRB and requests the model population in the second action or operation.

### Exemplary Computer-Implemented Methods for Simulating Responses

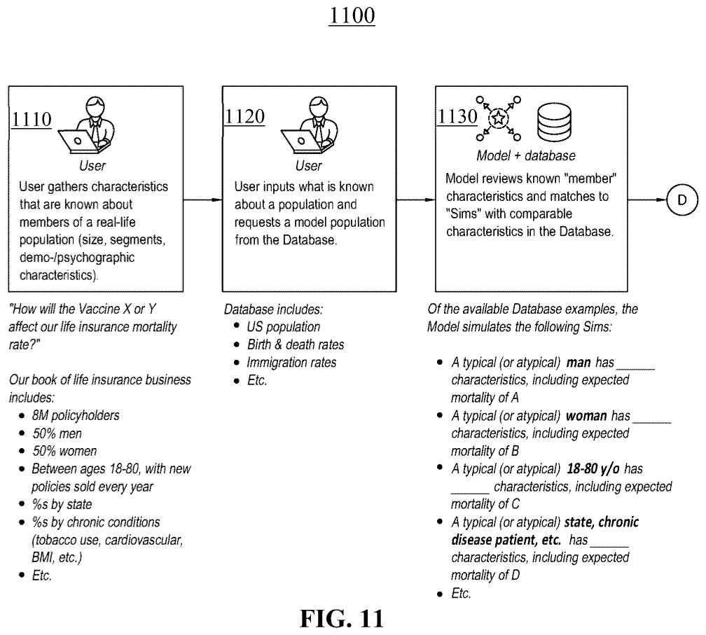

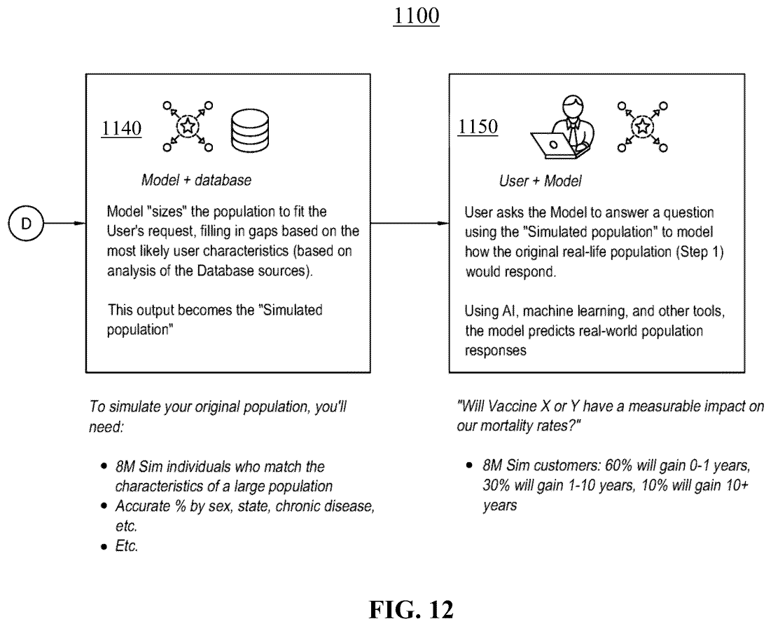

Turning ahead in the drawings, FIGS. 11-12 illustrate actions of an exemplary computer-implemented method 1100 for generating and using simulated characters to synthesize a simulated population in order to simulate responses by a population of insurance policyholders, according to one exemplary embodiment. The computer-implemented method 1100 is exemplary and is not limited to the embodiments presented herein. The computer-implemented method 1100 may be employed in many different embodiments or examples not specifically depicted or described herein.

In some embodiments, the procedures, the processes, the operations, the actions, and/or the activities of computer-implemented method 1100 may be performed in the order presented. In other embodiments, the procedures, the processes, the operations, the actions, and/or the activities of computer-implemented method 1100 may be performed in any suitable order. In still other embodiments, one or more of the procedures, the processes, the operations, the actions, and/or the activities of computer-implemented method 1100 may be combined or skipped. In many embodiments, method 1100 may be similar or identical to method 400 (FIG. 4), method 500 (FIG. 5), method 600 (FIGS. 6-8), and/or method 900 (FIGS. 9-10), and some or all of the procedures, the processes, the operations, the actions, and/or the activities of method 1100 may be similar or identical to the procedures, the processes, the operations, the actions, and/or the activities of method 400, method 500, method 600, and/or method 900.

In many embodiments, the computer system 300 or system 310 (FIG. 3) (including one or more of its elements, modules, and/or systems, such as character-simulating model 3110, population-generating model 3120, response-generating model 3130, etc.) may be suitable to perform method 1100 and/or one or more of the operations, actions, and/or activities of method 1100. In these or other embodiments, one or more of the operations, actions, and/or activities of method 1100 may be implemented as one or more computing instructions configured to run at one or more processors and configured to be stored at one or more non-transitory computer readable media. Such non-transitory computer readable media may be part of a computer system such as system 300 or system 310. The processor(s) may be similar or identical to the processor(s) described above with respect to computer system 100 (FIG. 1).

Referring to FIGS. 11-12, in many embodiments, the exemplary computer-implemented method 1100 may be adopted for generating and using virtual or simulated characters to synthesize a simulated population in order to simulate responses by a population, group, members of an organization, market segment, an affinity group, etc. (e.g., policyholders of life insurance policies issued by an insurance company; customers of a certain company; people that like to watch sports on television; auto insurance customers; homeowners insurance customers; football fans; fans of the Milwaukee Brewers; electrical and computer engineers; mothers or fathers; Republicans or Democrats, etc.).

The exemplary computer-implemented method 1100 may be similar or identical to method 400 (FIG. 4), method 500 (FIG. 5), method 600 (FIGS. 6-8), and/or method 900 (FIGS. 9-10), and/or any of the other exemplary methods discussed above. The method 1100 may include a block 1110 similar or identical to block 510 and/or block 610. Block 1110 may include receiving, via a user device (e.g., user device 350 (FIG. 3), computer system 100 (FIG. 1), etc.) for a user, known-member characteristic values for one or more known members of a real-life population (e.g., size, segments, demo-/psychographic characteristics, etc.).

In similar or different embodiments, block 1110 further may receive an inquiry input. The inquiry input may include or be associated with an inquiry and one or more known-member characteristic values. For example, the inquiry may be “How will a new drug or medicine affect or reduce our life insurance mortality rate and/or extend life expectancy?”, and the known-members may include (i) men and/or women over a certain age, and/or (ii) life insurance policy holders (e.g., 8 million policyholders, including approximately 50% men and 50% women, between ages 18-80, etc.). The exemplary known-member characteristic values may include one or more of gender, age, state, chronic condition(s), prescribed medications, exercise habits, health variables, family member information and medical history, surgery history, etc.

In certain embodiments, the exemplary computer-implemented method 1100 further may include a block 1120 similar, or identical, to block 410 (FIG. 4), block 520 (FIG. 5), block 620 (FIGS. 6-8), and/or block 920 (FIGS. 9-10). Block 1120 may include allowing a user to input what is known about the real-life population (such as a population, group, members of an organization, market segment, an affinity group, etc.) (e.g., the policyholders of a certain kind of insurance, customers of a company, users of a specific product or service, fans of a sport or specific team, members of an organization, members of a political party, etc.) and request a model population from a database (e.g., database(s) 330, a member database, a customer database, etc.). Block 1120 may be performed by computer system 300, system 310, or character-simulating model 3110 (FIG. 3). The input in this action or operation (e.g., what is known about the policyholders, group members, products or services, etc.) may include member characteristics associated with or defining population groups, such as market segments, affinity groups, etc.

The population groups may include a first population group including approximately 4 million male policyholders (gender=male), a second population group including approximately 4 million female policyholders (gender=female), third population groups each including respective policyholders grouped based upon their respective ages (e.g., 18≤age<25, 25≤age<35, 35≤age<45 . . . ), fourth population groups each including respective policyholders grouped based upon their respective chronic conditions (e.g., state=Alabama, state=Alaska, . . . ), fifth population groups each including respective policyholders grouped based upon their respective chronic conditions, etc. The model population may include some or all of the population groups in the examples above.

The exemplary computer-implemented method 1100 further may include a block 1130 similar or identical to block 420 (FIG. 4), block 530 (FIG. 5), block 630 (FIGS. 6-8), and/or block 930 (FIGS. 9-10). Block 1130 may include reviewing the known-member characteristics and matching the known members to simulated characters (e.g., the “Sims”) with comparable characteristics in the database (e.g., database(s) 330 (FIG. 3), the customer database, etc.). Block 1130 may be performed manually by a user or automatically by a system or model (e.g., system 300, system 310, or character-simulating model 3110 (FIG. 3)). In some embodiments, before matching the known members to the simulated characters, block 1130 further may include determining the simulated characters for population groups in block 410.

In many embodiments, the exemplary computer-implemented method 1100 further may include a block 1140 similar or identical to block 430 (FIG. 4), block 540 (FIG. 5), block 640 (FIGS. 6-8), and/or block 940 (FIGS. 9-10). Block 1140 may include sizing the population to fit the user's request (to become a simulated population), filling in the gaps based upon the most likely user characteristics (based upon analysis of the database sources). Block 1140 may be performed by any suitable systems or models (e.g., system 300, system 310, or population-generating model 3120 (FIG. 3), etc.) to generate the simulated population.

The exemplary computer-implemented method 1100 further may include a block 1150 similar or identical to block 440 (FIG. 4), block 550 (FIG. 5), block 650 (FIGS. 6-8), and/or block 950 (FIGS. 9-10). Block 1150 may include receiving, from a user device, the inquiry (e.g., “Will new medication X have a measurable impact on our mortality rates and extend life expectancy?” or “Will proposed modification to product or service X result in greater usage or sales of product or service X, respectively”) and generating a respective answer or response to the inquiry for each known member based upon each simulated member of the simulated population. Block 1150 may be performed by any suitable systems or models (e.g., system 300, system 310, response-generating model 3130 (FIG. 3), etc.) to receive the inquiry and/or generate the respective answer. In the above-mentioned example above, among the responses for the eight million simulated characters, 60% may be associated with a first response or outcome (such as life expectancy or sales increasing); 30% may be associated with a second response or outcome (such as life expectancy or sales remaining the same or approximately the same); and 10% may be associated with a third response (such as sales declining with a proposed modification).

In several embodiments, the exemplary computer-implemented method 1100 further may include an additional block (e.g., a sixth action or operation, not shown) similar or identical to block 560 (FIG. 5) and/or block 660 (FIGS. 6-8). The sixth action or operation may include of using a Large Language Model (LLM) (e.g., system 300, system 310, or response-generating model 3130 (FIG. 3)) trained to determine a respective explanation or reason for the respective answer. For example, the explanations for the responses, as determined in the fifth activity, action, or operation, may include: “30% of your insured population exercise regularly, and this number is expected to grow during the pandemic. Those that exercise more tend have a longer life expectancy,” and so forth.

In several embodiments, the exemplary computer-implemented method further may include another additional block (e.g., a seventh action or operation, not shown) similar or identical to block 450 (FIG. 4). The seventh action or operation may include transmitting, via a computer network (e.g., computer network 340), the simulated responses, including the responses and explanations, as determined above, to be displayed on a user interface executed on a user device (e.g., user device 350 (FIG. 3)).

### Exemplary Determining a Simulated Population Based Upon Simulated Characters

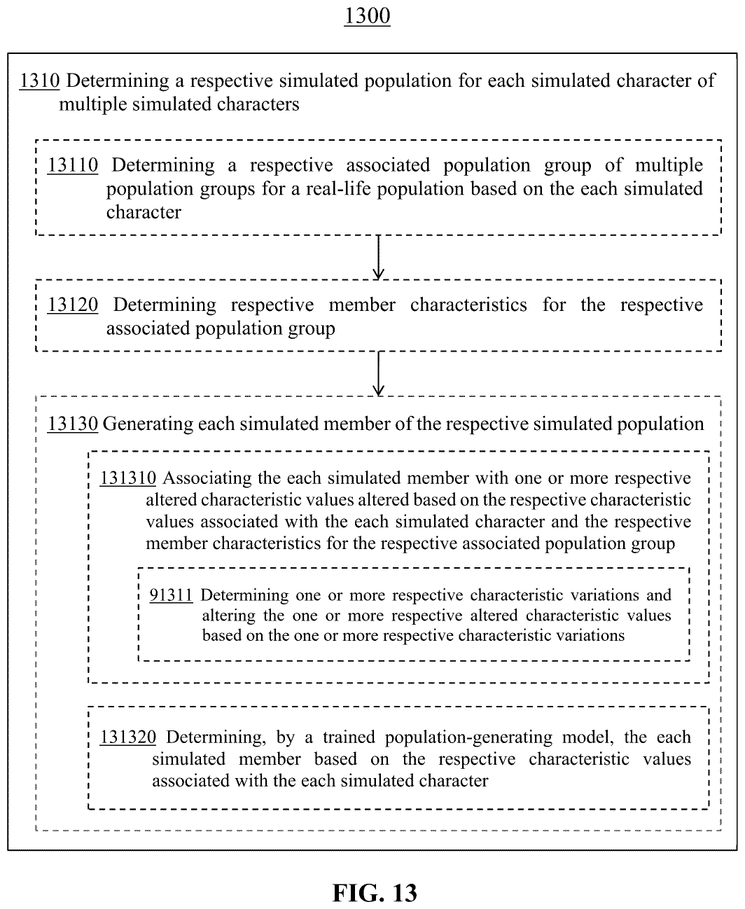

Turning ahead in the drawings, FIG. 13 illustrates actions or operations of a computer-implemented method 1300 for generating a simulated population based upon simulated characters, according to certain embodiments. The computer-implemented method 1300 is exemplary and not limited to the embodiments presented herein. The computer-implemented method 1300 may be employed in many different embodiments or examples not specifically depicted or described herein. In some embodiments, the procedures, the processes, operations, actions, and/or the activities of computer-implemented method 1300 may be similar or identical to the procedures, the processes, operations, actions, and/or the activities of method 400 (FIG. 4), method 500 (FIG. 5), and/or other exemplary methods discussed above. In some embodiments, the procedures, the processes, operations, actions, and/or the activities of computer-implemented method 1300 may be performed in the order presented. In other certain embodiments, the procedures, the processes, operations, actions, and/or the activities of method 1300 may be performed in any suitable order. In still other embodiments, one or more of the procedures, the processes, operations, actions, and/or the activities of method 1300 may be combined or skipped.

In many embodiments, system 300 or system 310 (FIG. 3) (including one or more of its elements, modules, and/or systems, such as character-simulating model 3110, population-generating model 3120, response-generating model 3130, etc.) may be suitable to perform computer-implemented method 1300 and/or one or more of the operations, actions, and/or activities of method 1300. In these or other embodiments, one or more of the operations, actions, and/or activities of method 400 may be implemented as one or more computing instructions configured to run at one or more processors and configured to be stored at one or more non-transitory computer readable media. Such non-transitory computer readable media may be part of a computer system such as system 300 or system 310. The processor(s) may be similar or identical to the processor(s) described above with respect to computer system 100.

Referring to FIG. 13, computer-implemented method 1300 may include a block 1310 of determining a respective simulated population for each simulated character of multiple simulated characters based upon respective characteristic values associated with each simulated character. In many embodiments, block 1310 may include a block 13110 of determining a respective associated population group of multiple population groups for a real-life population (e.g., insurance policyholders for an insurance company, customers of a retailer, owners of vehicles manufactured by an automobile manufacture, members of a target or niche market, homeowners, members of the sharing economy, fans of a sports team, users of specific products or services, etc.) based upon each simulated character. In certain embodiments, each simulated character may be associated with a single associated population group (such as those mentioned above or others, such as customers of a chain restaurant (McDonald's, Starbucks, etc.), users of a specific product or service, members of an affinity group, etc.), and an associated population group thus may be determined based upon the corresponding simulated character.

In many embodiments, block 1310 further may include a block 13120 of determining respective member characteristics for the respective associated population group. The respective member characteristics for the respective associated population group may be determined by receiving, via a user device from a user, the respective member characteristics for the respective associated population group. In similar or different embodiments, the respective member characteristics may be retrieved from a database (e.g., database(s) 330 (FIG. 3)) or a computer-readable storage medium (e.g., memory storage unit 208 (FIG. 2), hard drive 114 (FIGS. 1-2), CD-ROM and/or DVD drive 116 (FIGS. 1-2), a USB drive in USB port 112 (FIGS. 1-2), etc.).

In many embodiments, block 1310 further may include a block 13130 of generating each simulated member of the respective simulated population. Block 13130 may include a block 131310 of associating each simulated member with one or more respective altered characteristic values altered based upon the respective characteristic values associated with each simulated character and the respective member characteristics for the respective associated population group.

In some embodiments, block 131310 further may include a block 31311 of determining one or more respective characteristic variations (e.g., age variation=+5, residence variation=5-mile radius, income variation=+$5,000, etc.) for each simulated character of the multiple simulated characters based upon the respective member characteristics for the respective associated population group for each simulated character. The one or more respective characteristic variations may be determined by: (a) determining the one or more respective characteristic variations based upon respective statistics data for the respective member characteristics for the respective associated population group; (b) retrieving, from a database (e.g., database(s) 330), the one or more respective characteristic variations; and/or (c) receiving, via a user device (e.g., user device 350) from a user, the one or more respective characteristic variations. In a few embodiments, with the one or more respective characteristic variations determined, block 61311 further may include altering the one or more respective altered characteristic values for each simulated member based upon the one or more respective characteristic variations, as determined.

In similar or different embodiments, block 13130 additionally or alternatively may include a block 131320 of determining, by a trained population-generating model (e.g., population-generating model 3120 (FIG. 3), a GAN model, a VAE model, etc.), each simulated member based upon the respective characteristic values associated with each simulated character. In several embodiments, block 1310, 13130, or 131320 further may include receiving, from a user device (e.g., user device 350) for a user, user feedback for the respective simulated population, as determined in block 131320, and then re-training the trained population-generating model based upon the respective simulated population, as determined, and the user feedback, as received.

In certain embodiments, the computer-implemented method 1300 further may include generating one or more simulated responses to an inquiry for the real-life population based upon the respective simulated population for each simulated character of the multiple simulated characters, as determined in block 1310. Generating one or more simulated responses in method 1300 may be similar or identical to block 440 (FIG. 4) or block 550 (FIG. 5). The one or more simulated responses, as generated, may be transmitted to be displayed on a user interface executed on a user device (e.g., user device 350) for a user (see, e.g., block 450). The one or more simulated responses may include answers and reasons for the answers and/or recommendations to the user.

In some embodiments, the one or more simulated responses may be generated by a trained response-generating model (e.g., response-generating model 3130 (FIG. 3), an LLM model, a BERT model, a GPT-4 model, etc.). After transmitting the one or more simulated responses, the computer-implemented method 1300 may also include receiving, from a user device (e.g., user device 350), user feedback for the one or more simulated responses, and re-training the trained response-generating model based upon the one or more simulated responses, as determined, and the user feedback, as received. In certain embodiments, block 1310, 13130, or 131320 further may include re-training the trained population-generating model based upon the one or more simulated responses, as determined, and the user feedback for the one or more simulated responses, as received.

In many embodiments, the user devices and the users referred to above for: (a) inputting the inquiry, (b) receiving the one or more simulated responses, (c) providing the user feedback, (d) inputting characteristic variations, and/or (e) providing the member characteristics for the respective associated population group, may be the same or different user devices and users respectively.

### Exemplary Embodiments for Generating Simulated Responses by a Machine-Learning Model

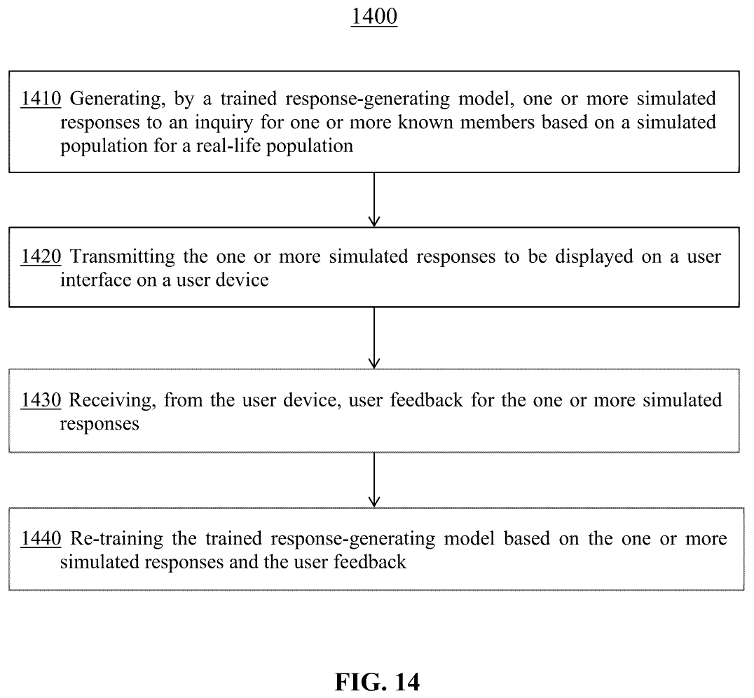

Turning ahead in the drawings, FIG. 14 illustrates the actions or operations of a computer-implemented method 1400 for generating simulated responses by a real-life population to user inquiries, according to one embodiment. The computer-implemented method 1400 is exemplary and is not limited to the embodiments presented herein. The computer-implemented method 1400 may be employed in many different embodiments or examples not specifically depicted or described herein. In certain embodiments, the procedures, the processes, the operations, the actions, and/or the activities of computer-implemented method 1400 may be similar or identical to the procedures, the processes, the actions, the operations, and/or the activities of method 400 (FIG. 4), method 500 (FIG. 5), method 600 (FIGS. 6-8), method 900 (FIGS. 9-10), method 1100 (FIGS. 11-12), method 1300 (FIG. 13), and/or other exemplary methods discussed above. In some embodiments, the procedures, the processes, the actions, the operations, and/or the activities of computer-implemented method 1400 may be performed in the order presented. In other embodiments, the procedures, the processes, the actions, the operations, and/or the activities of computer-implemented method 1400 may be performed in any suitable order. In still other embodiments, one or more of the procedures, the processes, the actions, the operations, and/or the activities of method 1400 may be combined or skipped.

In many embodiments, system 300 or system 310 (FIG. 3) (including one or more of its elements, modules, and/or systems, such as character-simulating model 3110, population-generating model 3120, response-generating model 3130, etc.) may be suitable to perform computer-implemented method 1400 and/or one or more of the activities, actions, and/or operations of computer-implemented method 1400. In these or other embodiments, one or more of the activities, actions, and/or operations of method 1400 may be implemented as one or more computing instructions configured to run at one or more processors and configured to be stored at one or more non-transitory computer readable media. Such non-transitory computer readable media may be part of a computer system such as system 300 or system 310. The processor(s) may be similar or identical to the processor(s) described above with respect to computer system 100.

Referring to FIG. 14, in many embodiments, the computer-implemented method 1400 may include a block 1410 of generating, by a trained response-generating model (e.g., response-generating model 3130 (FIG. 3), an LLM model, a GPT-4 model, a Lambda model, etc.), one or more simulated responses to an inquiry for one or more known members based upon a simulated population for a real-life population. The one or more simulated responses may include answers, reasons for the answers, and/or recommendations—and/or other feedback or suggestions. Block 1410 may be similar or identical to block 440 (FIG. 4), block 550 (FIG. 5), and/or block 560 (FIG. 5), etc.

In many embodiments, computer-implemented method 1400 further may include a block 1420 of transmitting the one or more simulated responses, as generated in block 1410, to be displayed on a user interface executed on a user device (e.g., user device 350 (FIG. 3)) (see, e.g., block 450 (FIG. 4)). After transmitting the one or more simulated responses in block 1420, method 1400 also may include a block 1430 of receiving, from the user device, user feedback for the one or more simulated responses, as generated in block 1410.

In many embodiments, the computer-implemented method 1400 further may include a block 1440 of re-training the trained response-generating model based upon the one or more simulated responses, as determined in block 1410, and the user feedback, as received in block 1430.

In several embodiments, before generating the one or more simulated responses in block 1410, the computer-implemented method 1400 may also include receiving, via the user device (e.g., user device 350), an inquiry input from a user. The inquiry input may be associated with the inquiry and one or more known-member characteristic values for the one or more known members of the real-life population (e.g., 100 employees of a company, 3,000 insurance policyholders of all of the policy holders, 50 surgeons or patients of a hospital, 20 teachers and staff of a high school, etc.).

In many embodiments, before block 1410, the computer-implemented method 1400 further may include determining the simulated population for the real-life population. The computer-implemented method 1400 may determine the simulated population by one or more activities, actions, and/or operations of method 1300 (FIG. 6)). To determine the simulated population, the method 1400 also may include determining simulated characters for population groups for the real-life population based upon member characteristics for the population groups (see, e.g., block 410 (FIG. 4)). Each of the simulated characters may be associated with: (a) one of the population groups, and (b) respective characteristic values corresponding to the member characteristics. The member characteristics for the population group may be received via a user device from a user or retrieved from a database or a storage device.

In a few embodiments, to determine the simulated characters, the method 1400 further may include retrieving, from a member database (e.g., database(s) 330), a model population for the real-life population (see, e.g., block 520 (FIG. 5)). The model population may be retrieved based upon the member characteristics for the population groups. After receiving the model population, determining the simulated characters further may be based upon the model population.

In similar or different embodiments, the computer-implemented method 1400 further may include generating the simulated characters by a trained character-simulating model (e.g., character-simulating model 3110, a logistic regression model, a neural network model, a ChatGPT-based model, etc.) based upon the member characteristics for the population groups. In a few embodiments, after receiving the user feedback in block 1420, the method 1400 further may include re-training the trained character-simulating model based upon the simulated characters, as generated, and the user feedback, as received.

In certain embodiments, before determining the simulated population, the computer-implemented method 1400 further may include determining one or more characteristic variations for the respective characteristic values for the one or more matched simulated characters. The simulated population further may be determined based upon the one or more characteristic variations (see, e.g., block 61311 (FIG. 6)). In similar or different embodiments, the method 1400 may determine the simulated population by a trained population-generating model (e.g., population-generating model 3120 (FIG. 3), a GAN model, a statistical-distribution-based data generating model, etc.) based upon the one or more matched simulated characters (see, e.g., block 61320 (FIG. 6)). In some embodiments where the trained population-generating model is used, after receiving the user feedback, the method 1400 further may include re-training the trained population-generating model based upon the simulated population, as determined, and the user feedback and/or other recommendations, as received.

In many embodiments, to determine the simulated population, the computer-implemented method 1400 further may include determining one or more matched simulated characters of the simulated characters for the one or more known members of the real-life population based upon the one or more known-member characteristic values associated with the one or more known members (see, e.g., block 420 (FIG. 4), block 530 (FIG. 5), etc.). The method 1400 may also include determining the simulated population for the real-life population based upon the one or more matched simulated characters, as determined (see, e.g., block 430, block 540, etc.).

### Exemplary Machine Learning Models

In many embodiments, the computer systems and/or computer-implemented methods may use one or more ML/AI models (e.g., character-simulating model 3110, population-generating model 3120, response-generating model 3130, NLP models, etc.) to perform one or more of the above-mentioned procedures, processes, activities, actions, operations, and/or methods. Examples of the algorithms used for the ML/AI models may include BERT, LLM, Lambda, Palm, XLNet, GPT-3, GPT-4, KNN, decision trees, linear regression, logistic regression, K-Means, neural networks, fuzzy logic, GANs, CTGAN, CNNs, VAEs, and so forth. In various embodiments, each of the ML/AI models used may be trained dynamically and/or regularly.

In many embodiments, the systems and/or methods may use one or more ML/AI models (e.g., character-simulating model 3110, population-generating model 3120, response-generating model 3130, NLP models, etc.) to perform one or more of the above-mentioned procedures, processes, activities, actions, operations, and/or methods. Examples of the algorithms used for the ML/AI models may include BERT, LLM, Lambda, Palm, XLNet, GPT-3, GPT-4, KNN, decision trees, linear regression, logistic regression, K-Means, neural networks, fuzzy logic, GANs, CTGAN, CNNs, VAEs, and so forth. In various embodiments, each of the ML/AI models used may be trained dynamically and/or regularly.

In many embodiments, the computer systems and/or computer-implemented methods may be configured to train or re-train the one or more ML/AI models. The training of each of the ML/AI models may be supervised, semi-supervised, and/or unsupervised-which in some embodiments may be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models may be collected from various data sources, including historical input and/or output data by the ML/AI model. The collection and update of the training data in the training datasets may be performed once, periodically (e.g., every day, every week, etc.), or constantly. For example, in certain embodiments, the input and/or output data of an ML/AI model may be curated by a user (e.g., an ML engineer, etc.) or automatically collected every time the ML/AI model generates new output data to update the training datasets for re-training the ML/AI model. In many embodiments, the trained and/or re-trained ML/AI model as well as the training datasets may be stored in, updated, and accessed from a database (e.g., database(s) 330).

In some embodiments, the users, computer systems, and/or computer-implemented methods further may determine whether to add the newly-created historical input and/or output data to the training dataset for retraining the ML/AI model based upon user feedback, predetermined criteria, and/or confidence scores for the historical output data. The user feedback may be associated with the output data of the ML/AI model (e.g., the simulated characters, the simulated population, the responses (such as virtual and/or simulated responses and recommendations, and/or actual responses or recommendations), etc.) or the output of the systems and/or methods using the ML/AI model (e.g., the simulated responses determined by method 400, method 500, etc.). Examples of user feedback may include a review score, one or more user actions (e.g., driving behavior changes as in telematics data tracked by driver's mobile devices, homeowner activity and behavior as determined by home telematics and other data, changes made in insurance claims process according to the proposed changes the inquiry, price sensitivity to various products or services, price sensitivity to insurance products or services, price and/or interest rate sensitivity to banking products (e.g., vehicle or home loans), etc.), and so forth.

In certain embodiments where machine learning techniques are not explicitly described in the processes, procedures, activities, operations, actions, and/or methods, such processes, procedures, activities, operations, actions, and/or methods may be read to include machine learning techniques suitable to perform the intended activities (e.g., determining, processing, analyzing, predicting, etc.). In several embodiments, the one or more ML/AI models may be configured to start or stop automatically upon occurrence of predefined events and/or conditions. In certain embodiments, the systems and/or methods may use a pre-trained ML/AI model, without any re-training.

### Exemplary Computer-Based Embodiments

Various embodiments may include a computer-implemented method for generating and using simulated or virtual characters to synthesize a simulated population in order to simulate responses by a population (such as a group of similarly situated individuals, members of a group or organization, market segment, other groups discussed previously, etc. as discussed further elsewhere herein). The method may be implemented via execution of computing instructions configured to run at one or more local or remote processors and stored at one or more local or remote non-transitory computer-readable media. In many embodiments, the method may include determining simulated characters for population groups or segments for a real-life population (or group) based upon member characteristics for the population groups. Each of the simulated characters may be associated with: (a) one of the population groups, and/or (b) respective characteristic values corresponding to the member characteristics. Examples of the real-life population may include insurance policyholders for an insurance company (such as for auto, homeowners, renters, life, health, personal articles, and other types of insurance); customers of a retailer; owners of vehicles manufactured by an automobile manufacture; customers of bank; loan holders; customers of financial services providers; members of a target or niche market; affinity groups, and/or other groups or populations mentioned elsewhere herein.

In certain embodiments, the member characteristics for the population groups may be received via a user device from a user. For instance, the user devices may include mobile devices, wearables, smart watches, smart glasses or contacts, augmented reality glasses, virtual reality headsets, mixed or extended reality headsets, voice bots, chat bots, ChatGPT bots, InstructGPT bots, Codex bots, Google Bard bots, video games, computers, laptops, and/or other electronic or electrical components, which may be in wired or wireless communication with one another.

In several embodiments, the simulated characters may be determined by retrieving, from a member database, a model population for the real-life population, and determined further based upon the model population. The model population may be retrieved based upon the member characteristics for the population groups. In similar or different embodiments, the simulated characters may be determined by generating the simulated characters by a trained character-simulating model based upon the member characteristics for the population groups. In certain embodiments where the trained character-simulating model is used, the computer-implemented method further may include, after transmitting the one or more simulated responses, receiving, from the user device, user feedback for the one or more simulated responses. The user feedback, as received, and the simulated characters, as generated, may be used for re-training the trained character-simulating model.

In certain embodiments, the computer-implemented method further may include determining one or more matched simulated characters of the simulated characters for one or more known members of the real-life population based upon one or more known-member characteristic values associated with the one or more known members. In some embodiments, before determining the one or more matched simulated characters, the method may also include receiving, via a user device, an inquiry input from a user. The inquiry input may be associated with the inquiry and the one or more known-member characteristic values for the one or more known members of the real-life population (such as a group, market segment, etc.). The user providing the inquiry input may be the same or different from the user inputting the member characteristics for the population groups.

In many embodiments, the computer-implemented method may include (i) determining a simulated population for the real-life population based upon the one or more matched simulated characters. In several embodiments, before determining the simulated population, the method further may include (ii) determining one or more characteristic variations for the respective characteristic values for the one or more matched simulated characters, and then (iii) determining the simulated population may be based upon the one or more characteristic variations. In certain embodiments, the method may (iv) determine the simulated population by a trained population-generating model based upon the one or more matched simulated characters. In certain embodiments where the trained population-generating model is used, the method may include (v) re-training the trained population-generating model may be based upon, at least in part, the simulated population and the user feedback.

In various embodiments, the computer-implemented method may include (i) generating one or more simulated responses to an inquiry for the one or more known members based upon the simulated population. The one or more simulated responses may include answers and reasons for the answers and/or recommendations to the user. In some embodiments, the method may (ii) generate the one or more simulated responses by a trained response-generating model. When the trained response-generating model is used, (iii) re-training the trained response-generating model may be based upon, at least in part, the one or more simulated responses and the user feedback.

In many embodiments, the computer-implemented method may include transmitting the one or more simulated responses to be displayed on a user interface executed on a user device.

Various embodiments may also include a computer system for generating and using virtual or simulated characters to synthesize a simulated population in order to simulate responses by a population (such as a group of individuals, such as members of a city or state or region, a market segments, users of a given product or service, fans of sports team, members of an organization, employees of a company, or other groups or populations discussed elsewhere herein). The system may include one or more processors and/or associated transceivers, and one or more non-transitory computer-readable media for storing computing instructions. The computing instructions, when run on the one or more processors and/or associated transceivers, may cause the one or more processors and/or associated transceivers to perform one or more acts that are similar to identical to the one or more activities, actions, and/or operations of the embodiments discussed above.

Various embodiments further may include a non-transitory computer readable storage medium storing one or more computing instructions that, when run on one or more processors, cause the one or more processors and/or associated transceivers to perform one or more acts for generating and using virtual or simulated characters to synthesize a simulated population in order to simulate responses by a population. The one or more acts may be similar to identical to the one or more activities, actions, and/or operations of the embodiments discussed above.

Various embodiments additionally may include a computer-implemented or computer-based method for determining a simulated population based upon multiple simulated characters. The method may be implemented via execution of computing instructions configured to run at one or more processors and stored at one or more non-transitory computer-readable media. In many embodiments, the method may include determining a respective simulated population for each simulated character of multiple simulated characters based upon respective characteristic values associated with each simulated character. The method may determine the respective simulated population for each simulated character by determining a respective associated population group of multiple population groups for a real-life population based upon each simulated character. Examples of the real-life population may include insurance policyholders for an insurance company (e.g., insureds for auto insurance, homeowners insurance, life insurance, health insurance, personal articles insurance, renter insurance, commercial or business insurance; and/or other types of insurance); customers of a retailer, bank, merchant, insurance provider; and/or financial services provider or bank; owners of vehicles manufactured by an automobile manufacture; homeowners; renters; members of a target market; or other real-life groups or populations, including those discussed elsewhere herein.

In certain embodiments, the computer-implemented method may determine the respective simulated population for each simulated character further by determining respective member characteristics for the respective associated population group. The respective member characteristics for the respective associated population group may be received via a user device from a user.

In many embodiments, the computer-implemented method may determine the respective simulated population for each simulated character further by generating each simulated member of the respective simulated population. Generating each simulated member may include associating each simulated member with one or more respective altered characteristic values altered based upon the respective characteristic values associated with each simulated character and the respective member characteristics for the respective associated population group.

In various embodiments, generating each simulated member of the respective simulated population for each simulated character further may include determining, by a trained population-generating model, each simulated member based upon the respective characteristic values associated with each simulated character. In several embodiments, the method may also include receiving, from a user device for a user, user feedback for the respective simulated population and then re-training the trained population-generating model based upon the respective simulated population and the user feedback.

In some embodiments, the computer-implemented method may also include determining one or more respective characteristic variations for each simulated character of the multiple simulated characters based upon the respective member characteristics for the respective associated population group for each simulated character. The one or more respective characteristic variations may be determined by: (a) determining the one or more respective characteristic variations based upon respective statistics data for the respective member characteristics for the respective associated population group; (b) retrieving, from a database, the one or more respective characteristic variations; and/or (c) receiving, via a user device from a user, the one or more respective characteristic variations. In a few embodiments, with the one or more respective characteristic variations determined, associating each simulated member with the one or more respective altered characteristic values may include altering the one or more respective altered characteristic values for each simulated member based upon the one or more respective characteristic variations.

In some embodiments, after determining the respective simulated population, the computer-implemented method further may include generating one or more simulated responses to an inquiry for the real-life population based upon the respective simulated population for each simulated character of the multiple simulated characters. The one or more simulated responses may be transmitted to be displayed on a user interface executed on a user device for a user. The one or more simulated responses may include answers and reasons for the answers and/or recommendations to the user.

In some embodiments, the one or more simulated responses may be generated by a trained response-generating model. After transmitting the one or more simulated responses, the computer-implemented method may include receiving, from a user device, user feedback for the one or more simulated responses, and re-training the trained response-generating model based upon the one or more simulated responses and the user feedback. In many embodiments, the user device(s) and the user(s) for providing the user feedback, inputting characteristic variations and/or providing the member characteristics for the respective associated population group and the user device and user for receiving the one or more simulated responses may respectively be the same or different.

Various embodiments may include a computer system for determining a simulated population based upon multiple simulated characters. The system may include one or more processors, and one or more non-transitory computer-readable media for storing computing instructions. The computing instructions, when run on the one or more processors, may cause the one or more processors to perform one or more acts that are similar to identical to the one or more activities, actions, and/or operations of the embodiments discussed above.

Various embodiments further may include a non-transitory computer readable storage medium storing one or more computing instructions that, when run on one or more processors, cause the one or more processors to perform one or more operations for determining a simulated population based upon multiple simulated characters. The one or more operations may be similar to identical to the one or more activities, actions, and/or operations of the embodiments discussed above.

Various embodiments additionally may include a computer-implemented method for generating simulated responses by a real-life population to user inquiries. The method may be implemented via execution of computing instructions configured to run at one or more processors and stored at one or more non-transitory computer-readable media. The method may include generating, by a trained response-generating model, one or more simulated responses to an inquiry for one or more known members based upon a simulated population for a real-life population. The one or more simulated responses may include answers and reasons for the answers and/or recommendations. Upon the generation of the one or more simulated responses, the method further may include transmitting the one or more simulated responses to be displayed on a user interface executed on a user device.

In many embodiments, the computer-implemented method may include receiving, from the user device, user feedback for the one or more simulated responses. The method may also include re-training the trained response-generating model based upon the one or more simulated responses and the user feedback.

In certain embodiments, before generating the one or more simulated responses, the computer-implemented method may include receiving, via the user device, an inquiry input from a user. The inquiry input may be associated with the inquiry and one or more known-member characteristic values for the one or more known members of the real-life population.

In many embodiments, the computer-implemented method may include determining the simulated population for the real-life population. To determine the simulated population, the method may include determining simulated characters for population groups for the real-life population based upon member characteristics for the population groups. Each of the simulated characters may be associated with: (a) one of the population groups, and (b) respective characteristic values corresponding to the member characteristics. The member characteristics for the population group may be received via a user device from a user.

In certain embodiments, to determine the simulated characters, the computer-implemented method may include retrieving, from a member database, a model population for the real-life population. The model population may be retrieved based upon the member characteristics for the population groups. After receiving the model population, determining the simulated characters further may be based upon the model population.

In similar or different embodiments, the computer-implemented method may include generating the simulated characters by a trained character-simulating model based upon the member characteristics for the population groups. In a few embodiments, after receiving the user feedback, the method may include re-training the trained character-simulating model based upon the simulated characters and the user feedback.

In several embodiments, before determining the simulated population, the computer-implemented method may include determining one or more characteristic variations for the respective characteristic values for the one or more matched simulated characters. The simulated population may be determined based upon the one or more characteristic variations. In similar or different embodiments, the method may determine the simulated population by a trained population-generating model based upon the one or more matched simulated characters. In embodiments where the trained population-generating model is used, after receiving the user feedback, the method may include re-training the trained population-generating model based upon the simulated population and the user feedback.

In many embodiments, to determine the simulated population, the computer-implemented method may include determining one or more matched simulated characters of the simulated characters for the one or more known members of the real-life population based upon the one or more known-member characteristic values associated with the one or more known members. The method may include determining the simulated population for the real-life population based upon the one or more matched simulated characters.

Various embodiments may include a computer environment or computer system for generating simulated responses by a real-life population to user inquiries. The computer system may include one or more local or remote processors and/or associated transceivers, and one or more local or remote non-transitory computer-readable media for storing computing instructions. The computing instructions, when run on the one or more processors, may cause the one or more processors to perform one or more acts that are similar or identical to the one or more activities, actions, and/or operations of the embodiments discussed above.

Various embodiments may include a non-transitory computer readable storage medium storing one or more computing instructions that, when run on one or more processors, cause the one or more processors to perform one or more operations for generating simulated responses by a real-life population to user inquiries. The one or more operations may be similar or identical to the one or more activities, actions, and/or operations of the embodiments discussed above.

Various applications may take advantage of the disclosed systems and/or methods to resolve problems surrounding generating insurance quotes, handling insurance claims, insurance premium determination, driver automobile behaviors, automobile manufacturing/repairing process, homeowner behavior, driver and/or vehicle owner recommendations, homeowner recommendations (such as suggestions for home maintenance or improvements), consumer buying decisions, price sensitivity of consumers, consumer brand loyalty, consumer reaction to changes or modifications to products or services, and so forth. Some applications may include predicting potential objective and/or subjective responses or reactions by a real-life population, such as, predicting how automobile drivers would use or not use a new technology on the vehicles, determining whether potential buyers would order more products in view of a to-be-launched reward program, predicting how fast automotive technicians may replace a recalled part on a vehicle or repair a damaged vehicle, estimating how many patients will be released from a hospital in 3 weeks after receiving a new treatment, etc.

In one aspect, a computer-implemented method of generating simulated responses via simulated characters may be provided. The method may be implemented via execution of computing instructions configured to run at one or more processors and stored at one or more non-transitory computer-readable media. The method may include (1) determining simulated characters for market segments or other groups for a real-life population based upon member characteristics for the market segments or other groups, respectively, wherein each of the simulated characters is associated with: (a) one of the market segments or other groups, and (b) respective characteristic values corresponding to the member characteristics; (2) determining one or more matched simulated characters of the simulated characters for one or more known members of the real-life population based upon one or more known-member characteristic values associated with the one or more known members; (3) determining a simulated population for the real-life population based upon the one or more matched simulated characters; (4) generating one or more simulated responses to an inquiry for the one or more known members based upon the simulated population; and/or (5) transmitting the one or more simulated responses to be displayed on a user interface on a user device. The method may include additional, less, or alternate functionality, including that discussed elsewhere herein.

In another aspect, a computer-implemented method for training a model based upon simulated responses and user feedback may be provided. The method may be implemented via execution of computing instructions configured to run at one or more processors and stored at one or more non-transitory computer-readable media. The method may include (1) generating, by a trained response-generating model, one or more simulated responses to an inquiry for one or more known members based upon a simulated population for a real-life market segment or other group; (2) transmitting the one or more simulated responses to be displayed on a user interface on a user device; (3) receiving, from the user device, user feedback for the one or more simulated responses; and/or (4) re-training the trained response-generating model based upon the one or more simulated responses and the user feedback. The method may include additional, less, or alternate functionality, including that discussed elsewhere herein.

In another aspect, a computer-implemented method for associating simulated characters with characteristics and/or population groups may be provided. The method may be implemented via execution of computing instructions configured to run at one or more processors and stored at one or more non-transitory computer-readable media. The method may include (1) determining a respective simulated population for each simulated character of multiple simulated characters based upon respective characteristic values associated with each simulated character; (2) determining a respective associated market segment or other group of multiple population groups for a real-life population based upon each simulated character; (3) determining respective member characteristics for the respective market segment or other group; and/or (4) generating each simulated member of the respective simulated population, comprising associating each simulated member with one or more respective altered characteristic values altered based upon the respective characteristic values associated with each simulated character and the respective member characteristics for the respective market segment or other group. The method may include additional, less, or alternate functionality, including that discussed elsewhere herein.

### Additional Considerations

Although generating simulated characters, determining simulated populations, and/or creating simulated responses by a real-life population or group has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. Additionally, one or more of the procedures, processes, operations, actions, and/or activities of the methods in FIGS. 4-7 may include different procedures, processes, actions, and/or activities and be performed by many different modules, in many different orders. As another example, the modules, models, elements, and/or systems within system 300 or system 310 in FIG. 3 may be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system may be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing Figures illustrate the general manner of construction, and descriptions and details of well-known features and techniques may be omitted to avoid unnecessarily obscuring the present disclosure. Additionally, elements in the drawing Figures are not necessarily drawn to scale. For example, the dimensions of some of the elements in the Figures may be exaggerated relative to other elements to help improve understanding of embodiments of the present disclosure. The same reference numerals in different Figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” may mean within plus or minus five percent of the stated value. In further embodiments, “approximately” may mean within plus or minus three percent of the stated value. In yet other embodiments, “approximately” may mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for associating simulated characters with characteristics and/or population groups, the method being implemented via execution of computing instructions configured to run at one or more processors and stored at one or more non-transitory computer-readable media, the computer-implemented method comprising:
determining a respective simulated population for each simulated character of multiple simulated characters based upon respective characteristic values associated with each simulated character, comprising:
determining a respective associated population group of multiple population groups for a real-life population based upon each simulated character;
determining respective member characteristics for the respective associated population group; and
generating each simulated member of the respective simulated population, comprising associating each simulated member with one or more respective altered characteristic values altered based upon the respective characteristic values associated with each simulated character and the respective member characteristics for the respective associated population group.

2. The computer-implemented method of claim 1, wherein generating each simulated member of the respective simulated population for each simulated character of the multiple simulated characters further comprises determining, by a trained population-generating model, each simulated member based upon the respective characteristic values associated with each simulated character.

3. The computer-implemented method of claim 2, the method further comprising:
receiving, from a user device for a user, user feedback for the respective simulated population; and
re-training the trained population-generating model based upon the respective simulated population and the user feedback.

4. The computer-implemented method of claim 1, the method further comprising one or more of:
determining one or more respective characteristic variations for each simulated character of the multiple simulated characters based upon the respective member characteristics for the respective associated population group for each simulated character, wherein associating each simulated member of the respective simulated population for each simulated character with the one or more respective altered characteristic values comprises altering the one or more respective altered characteristic values for each simulated member based upon the one or more respective characteristic variations; or
after determining the respective simulated population:
generating one or more simulated responses to an inquiry for the real-life population based upon the respective simulated population for each simulated character of the multiple simulated characters; and
transmitting the one or more simulated responses to be displayed on a user interface on a second user device for a second user.

5. The computer-implemented method of claim 4, wherein, when the one or more respective characteristic variations for each simulated character are determined, determining the one or more respective characteristic variations comprises at least one of:
determining the one or more respective characteristic variations based upon respective statistics data for the respective member characteristics for the respective associated population group;
retrieving, from a database, the one or more respective characteristic variations; or
receiving, via a third user device from a third user, the one or more respective characteristic variations.

6. The computer-implemented method of claim 4, wherein, when the one or more simulated responses are generated, one or more of:
the one or more simulated responses further comprise answers and at least one of reasons for the answers or recommendations; or
generating the one or more simulated responses comprises generating the one or more simulated responses by a trained response-generating model.

7. The computer-implemented method of claim 6, further comprising, after transmitting the one or more simulated responses:
receiving, from the second user device, user feedback for the one or more simulated responses; and
when the trained response-generating model is used, re-training the trained response-generating model based upon the one or more simulated responses and the user feedback.

8. The computer-implemented method of claim 1, wherein determining the respective member characteristics for the respective associated population group comprises receiving, via a third user device from a third user, the respective member characteristics for the respective associated population group.

9. The computer-implemented method of claim 1, wherein the real-life population comprises one or more of:
customers of a retailer;
owners of vehicles manufactured by an automobile manufacture;
homeowners; or
members of a target market.

10. A computer system for associating simulated character with characteristics and/or population groups, the computer system comprising:
one or more processors; and
one or more non-transitory computer-readable media storing computing instructions that, when run on the one or more processors, direct the one or more processors to perform the following operations:
determining a respective simulated population for each simulated character of multiple simulated characters based upon respective characteristic values associated with each simulated character, comprising:
determining a respective associated population group of multiple population groups for a real-life population based upon each simulated character;
determining respective member characteristics for the respective associated population group; and
generating each simulated member of the respective simulated population comprising associating each simulated member with one or more respective altered characteristic values altered based upon the respective characteristic values associated with each simulated character and the respective member characteristics for the respective associated population group.

11. The computer system of claim 10, wherein generating each simulated member of the respective simulated population for each simulated character of the multiple simulated characters further comprises:
determining, by a trained population-generating model, each simulated member of the respective simulated population based upon the respective characteristic values associated with each simulated character;
receiving, from a user device for a user, user feedback for the respective simulated population; and
re-training the trained population-generating model based upon the respective simulated population and the user feedback.

12. The computer system of claim 10, wherein the computing instructions, when run on the one or more processors, further cause the one or more processors to perform one or more of:
determining one or more respective characteristic variations for each simulated character of the multiple simulated characters based upon the respective member characteristics for the respective associated population group for each simulated character, wherein associating each simulated member of the respective simulated population for each simulated character with the one or more respective altered characteristic values comprises altering the one or more respective altered characteristic values for each simulated member based upon the one or more respective characteristic variations; or
after determining the respective simulated population:
generating one or more simulated responses to an inquiry for the real-life population based upon the respective simulated population for each simulated character of the multiple simulated characters; and
transmitting the one or more simulated responses to be displayed on a user interface on a second user device for a second user.

13. The computer system of claim 12, wherein when the one or more respective characteristic variations for each simulated character are determined, determining the one or more respective characteristic variations comprises at least one of:
determining the one or more respective characteristic variations based upon respective statistics data for the respective member characteristics for the respective associated population group;
retrieving, from a database, the one or more respective characteristic variations; or
receiving, via a third user device from a third user, the one or more respective characteristic variations.

14. The computer system of claim 12, wherein when the one or more simulated responses are generated, one or more of:
the one or more simulated responses further comprise answers and at least one of: reasons for the answers or recommendations; or
generating the one or more simulated responses comprises generating the one or more simulated responses by a trained response-generating model;
receiving, from the second user device, user feedback for the one or more simulated responses; and
when the trained response-generating model is used, re-training the trained response-generating model based upon the one or more simulated responses and the user feedback.

15. The computer system of claim 12, wherein determining the respective member characteristics for the respective associated population group comprises receiving, via a third user device from a third user, the respective member characteristics for the respective associated population group.

16. A non-transitory computer readable storage medium storing one or more computing instructions that direct processor operations of one or more processors, the one or more computing instructions, when run on one or more processors, cause the one or more processors to perform:
determining a respective simulated population for each simulated character of multiple simulated characters based upon respective characteristic values associated with each simulated character, comprising:
determining a respective associated population group of multiple population groups for a real-life population based upon each simulated character;
determining respective member characteristics for the respective associated population group; and
generating each simulated member of the respective simulated population comprising associating each simulated member with one or more respective altered characteristic values altered based upon the respective characteristic values associated with each simulated character and the respective member characteristics for the respective associated population group.

17. The non-transitory computer readable storage medium of claim 16, wherein generating each simulated member of the respective simulated population for each simulated character of the multiple simulated characters further comprises:
determining, by a trained population-generating model, each simulated member based upon the respective characteristic values associated with each simulated character;
receiving, from a user device for a user, user feedback for the respective simulated population; and
re-training the trained population-generating model based upon the respective simulated population and the user feedback.

18. The non-transitory computer readable storage medium of claim 17, wherein the one or more computing instructions that, when run on one or more processors, further cause the one or more processors to perform one or more of:
determining one or more respective characteristic variations for each simulated character of the multiple simulated characters based upon the respective member characteristics for the respective associated population group for each simulated character, wherein associating each simulated member of the respective simulated population for each simulated character with the one or more respective altered characteristic values comprises altering the one or more respective altered characteristic values for each simulated member based upon the one or more respective characteristic variations; or
after determining the respective simulated population:
generating one or more simulated responses to an inquiry for the real-life population based upon the respective simulated population for each simulated character of the multiple simulated characters; and
transmitting the one or more simulated responses to be displayed on a user interface on a second user device for a second user.

19. The non-transitory computer readable storage medium of claim 18, wherein:
when the one or more respective characteristic variations for each simulated character are determined, determining the one or more respective characteristic variations comprises at least one of:
determining the one or more respective characteristic variations based upon respective statistics data for the respective member characteristics for the respective associated population group;
retrieving, from a database, the one or more respective characteristic variations; or
receiving, via a third user device from a third user, the one or more respective characteristic variations; and
when the one or more simulated responses are generated, one or more of:
the one or more simulated responses further comprise answers and at least one of:
reasons for the answers or recommendations; or
generating the one or more simulated responses comprises generating the one or more simulated responses by a trained response-generating model;
receiving, from the second user device, user feedback for the one or more simulated responses; and
when the trained response-generating model is used, re-training the trained response-generating model based upon the one or more simulated responses and the user feedback.

20. The non-transitory computer readable storage medium of claim 16, wherein determining the respective member characteristics for the respective associated population group comprises receiving, via a third user device from a third user, the respective member characteristics for the respective associated population group.

21. A computer-implemented method for associating simulated characters with characteristics and/or population groups, the method being implemented via execution of computing instructions configured to run at one or more processors and stored at one or more non-transitory computer-readable media, the computer-implemented method comprising:
determining a respective simulated population for each simulated character of multiple simulated characters based upon respective characteristic values associated with each simulated character, comprising:
determining a respective associated market segment or other group of multiple population groups for a real-life population based upon each simulated character;
determining respective member characteristics for a respective market segment or other group; and/or
generating each simulated member of the respective simulated population, comprising associating each simulated member with one or more respective altered characteristic values altered based upon the respective characteristic values associated with each simulated character and the respective member characteristics for the respective market segment or other group.
